(19) United States
(12) Patent Application Publication
(10) Pub. No.: US 2018/0362405 A1
(43) Pub. Date: Dec. 20, 2018

(54) RESIN COMPOSITION AND METHOD FOR PRODUCING SAME

(71) Applicants: Kyoto University, Kyoto-shi (JP); DIC Corporation, Tokyo (JP)

(72) Inventors: Yoshinobu Tsujii, Kyoto-shi (JP); Keita Sakakibara, Kyoto-shi (JP); Tetsuya Harada, Sakura-shi (JP); Takahito Ikuma, Sakura-shi (JP); Junya Okawa, Shikokuchuo-shi (JP); Ikko Matsusue, Shikokuchuo-shi (JP); Junji Shinya, Ichihara-shi (JP)

(73) Assignees: Kyoto University, Kyoto-shi (JP); DIC Corporation, Tokyo (JP)

(21) Appl. No.: 15/780,033

(22) PCT Filed: Dec. 1, 2016
(86) PCT No.: PCT/JP2016/085666

§ 371 Date: May 30, 2018

(30) Foreign Application Priority Data
Dec. 3, 2015 (JP) 2015-237019
Oct. 12, 2016 (JP) 2016-201243

(51) Int. Cl. C04B 26/22; C08K 5/21; C08K 5/09; C08K 7/02; C08L 97/02; C08L 1/02

(52) U.S. Cl. CPC C04B 26/22; C08K 5/21; C08K 5/09; C08L 2205/16; C08L 97/02; C08L 1/02; C08K 7/02

(57) ABSTRACT

An object is to establish a technique for producing a resin composite material at low cost. A resin composition contains cellulose fibers, a fibrillation aid, and a resin.

### TECHNICAL FIELD

The present invention relates to a resin composition and a method for producing the same.

### BACKGROUND ART

Cellulose fibers are fibers having a light weight of ⅕ of steel, a strength of 5 times or more as high as steel, and a low coefficient of linear thermal expansion of 1/50 of glass. There is a technique for imparting mechanical strength to a resin composition by using as a matrix a resin or the like containing cellulose fibers as a filler.

Also, cellulose nanofibers (CNF, also referred to as microfibrillated plant fibers (MFC) or the like) are produced by fibrillating cellulose fibers for the purpose of further improving the mechanical strength possessed by cellulose fibers.

CNF refers to fibers produced by treating cellulose fibers by mechanical fibrillation or the like and to fibers having a fiber width of about 4 to 100 nm and a fiber length of about 5 μm. The CNF has a high specific surface area (250 to 300 m²/g) and has a light weight and high strength as compared with steel.

In order to produce a resin composite material showing light weight and high strength by using CNF, there are roughly three problems. The first is to establish a technique for producing a resin composite material at low cost. The second is to establish a technique for preparing CNF by fibrillating cellulose fibers to the nano-level size and satisfactorily dispersing CNF in a resin. The third is to establish a technique for reinforcing the interface between CNF and a resin component.

In order to solve the second and third problems, the inventors of the present invention have developed a technique using a specified polymer dispersant (Patent Literature 1). Patent Literature 2 describes that a component such as urea, biuret, or the like is added to CNF for the purpose of improving dispersibility of CNF and improving the mechanical physical properties of a resin composite material. However, the component such as urea, biuret, or the like described in Patent Literature 2 is not a component which improves pulp fibrillation.

### CITATION LIST

### Patent Literature

PTL 1: Japanese Unexamined Patent Application Publication No. 2014-162880

PTL 2: Japanese Unexamined Patent Application Publication No. 2014-227639

### SUMMARY OF INVENTION

### Technical Problem

An object of the present invention is to solve the first problem, that is, to establish a technique for producing a resin composite material at low cost.

### Solution to Problem

The present inventors have repeated eager researches for solving the problems.

A process which has been investigated for producing a CNF-reinforced resin includes first producing CNF by micronizing (fibrillating to the nano-level) a plant raw material and then kneading the CNF with a resin. This is a two-step process including producing CNF and kneading the CNF with a resin. In this process, CNF is generally produced in water. The CNF shows very high hydrophilicity and a large specific surface area, and thus the CNF contains water in an amount of about 100 times the CNF amount.

In order to knead the hydrous CNF with a hydrophobic (lipophilic) resin, it is necessary to remove the unnecessary water contained in the hydrous CNF and to prevent self-aggregation of CNF, which proceeds simultaneously with the removal of water. This is a factor for the increased production cost in producing a CNF-reinforced resin.

Therefore, it is necessary to develop a method for producing a CNF-reinforced resin, in which the preparation of CNF, dispersion of CNF in a resin, and compounding of CNF with a resin can be simultaneously performed. The method for producing a CNF-reinforced resin becomes a process with a low environmental load which is thus a process capable of realizing low cost and high practicality.

The present invention has been achieved by further repeated eager researches, and thus the technique described above can be realized.

Item 1.

A resin composition containing cellulose fiber, a fibrillation aid, and a resin.

Item 2.

The resin composition described in Item 1, further containing a dispersant.

Item 3.

The resin composition described in Item 1 or 2, wherein the cellulose fibers are cellulose nanofibers.

Item 4.

The resin composition described in any one of Items 1 to 3, wherein the fibrillation aid is at least one component selected from the group consisting of urea, biuret, biurea, hydrazide, saccharides, saccharide alcohols, organic acids, and organic acid salts.

Item 5.

The resin composition described in any one of Items 2 to 4, wherein the dispersant is a component having a resin-affinitive segment A and a cellulose-affinitive segment B and having a block copolymer structure or a gradient copolymer structure.

Item 6.

A method for producing a resin composition containing cellulose fibers, a fibrillation aid, and a resin, the method including, in order:

(1) a step of mixing pulp with a resin; and

(2) a step of fibrillating the pulp by kneading the mixture of the step (1) to produce a resin composition containing cellulose fibers and a resin,

Wherein at least one step selected from the mixing step in the step (1), the kneading step in the step (2), and the fibrillating step in the step (2) includes a step of adding the fibrillation aid.

Item 7.

The method described in Item 6, wherein at least one step selected from the mixing step in the step (1), the kneading step in the step (2), and the fibrillating step in the step (2) includes a step of adding a dispersant.

Item 8.

The method described in Item 6 or 7, wherein the cellulose fibers contained in the resin composition are cellulose nanofibers.

Item 9.

A composition for producing a resin composition, the composition containing cellulose fibers and a fibrillation aid.

Item 10.

The composition described in Item 9, further containing a dispersant.

The present invention permits the preparation of CNF and dispersion of CNF in a resin to be performed by a simple operation, and this is a simultaneous process (Simultaneous nano-Fibrillation Compounding Process, SFC process) of nano-fibrillation (fibrillation to the nano-level) and nano-dispersion (dispersion in the nano-level).

The present invention can develop a SFC process and realize a reduction of production cost of a CNF-reinforced resin composite material.

The present inventors have developed an aqueous pretreatment process without using an organic solvent. This process can efficiently produce CNF from wood-derived pulp by a kneading treatment using a twin-screw extruder or the like. At the same time, the process can satisfactorily disperse the resultant CNF in a resin.

A technique of the present invention for producing a resin composite material at low cost is characterized by using the fibrillation aid and preferably the dispersant (more preferably, a water-soluble dispersant) for the pulp.

In the present invention, a mixture (premix) is prepared by adding the fibrillation aid and the resin (high-density polyethylene or the like) to the wood-derived pulp. The pulp is fibrillated to the nano-level by melt-kneading the mixture by using a twin-screw extruder or the like. As a result, a resin composite material containing CNF and showing high mechanical properties can be produced.

In the present invention, a resin composite material showing higher mechanical properties can be more preferably produced by using, as a raw material, the wood-derived pulp treated with a dispersant (more preferably, a polymer dispersant).

The present invention can prepare a composite resin material without using a special dehydrator and can provide a process for producing a composite resin material with low cost and low environmental load.

### Advantageous Effects of Invention

The present invention can provide a process for producing a composite resin material with low cost and low environmental load.

The present invention can produce a composite resin material containing CNF and showing high mechanical properties.

### BRIEF DESCRIPTION OF DRAWINGS

FIG. 1 is a drawing showing outlines of a polymer dispersant.

FIG. 2 is a drawing showing a nano-fibrillation-nano-dispersion simultaneous process (SFC process).

FIG. 3 is a diagram showing tension-strain curves (SS curves) indicating a urea addition effect.

FIG. 4 is a diagram showing the results of polarized light microscopy of CNF/PE composites each using urea as a fibrillation aid.

FIG. 5 is a diagram showing tension-strain curves (SS curves) of CNF/PE composites each containing both a dispersant and urea.

FIG. 6 is a diagram showing the results of polarized light microscopy of CNF/PE composites each containing both a dispersant and urea.

FIG. 7 is a diagram showing a relation between the amount of dispersant added and mechanical properties in CNF/PE composites.

FIG. 8 is a diagram showing tension-strain curves (SS curve) of CNF/PE composites formed with different kneading times.

FIG. 9 is a diagram showing the results of polarized light microscopy of CNF/PE composites formed with different kneading times.

FIG. 10 is a diagram showing X-ray CT indicating fibrillation properties in composites.

FIG. 11 is a diagram showing X-ray CT indicating fibrillation properties in composites.

FIG. 12 is a diagram showing tension-strain curves (SS curve) of composites formed by using different types of pulp.

FIG. 13 is a diagram showing the results of polarized light microscopy of composites formed by using different types of pulps.

FIG. 14 is a diagram showing the results of SEM observation of cellulose fiber portions remaining after hot-xylene treatment of composites.

FIG. 15 is a diagram showing a tension-strain curve (SS curve) of a composite using D-glucose as a fibrillation aid.

FIG. 16 is a diagram showing the results of polarized light microscopy of a composite using D-glucose as a fibrillation aid.

FIG. 17 is a diagram showing tension-strain curves (SS curves) of composites composed of premix PM6/dispersant 3/HDPE/various fibrillation aids.

FIG. 18 is a diagram showing the results of polarized light microscopy of composites composed of premix PM6/dispersant 3/HDPE/various fibrillation aids.

FIG. 19 is a diagram showing the results of polarized light microscopy of composites composed of premix PM6/dispersant 3/HDPE/various fibrillation aids.

FIG. 20 is a diagram showing tension-strain curves (SS curve) of composites composed of premix PM6/dispersant 3/HDPE/various fibrillation aids.

FIG. 21 is a diagram showing the results of polarized light microscopy of composites composed of premix PM6/dispersant 3/HDPE/various fibrillation aids.

### DESCRIPTION OF EMBODIMENTS

(1) Resin Composition

A resin composition of the present invention contains cellulose fibers, a fibrillation aid, and a resin.

The resin composition of the present invention preferably further contains a dispersant.

The cellulose fibers are preferably cellulose nanofibers (CNF). That is, the resin composition as a final product preferably contains CNF produced by fibrillating pulp.

The cellulose fibers in the resin composition of the present invention are preferably fibrillated to the nano-level size. In the resin composition of the present invention, CNF is satisfactorily dispersed in the resin, and the interface between the CNF and the resin is reinforced.

The resin composition of the present invention is a composite resin material containing CNF and exhibiting high mechanical properties. The resin composition of the present invention becomes a composite resin material exhibiting higher mechanical properties by more preferably using wood-derived pulp treated with a dispersant (more preferably, a polymer dispersant) as a raw material.

The resin composition of the present invention contains the cellulose fibers (CNF) satisfactorily dispersed in the resin by using the fibrillation aid.

(1-1) Cellulose Fibers

The cellulose fibers (also simply referred to as “cellulose”) can be prepared by using, as a raw material, plant fibers such as pulp or the like which can be produced from a natural plant raw material such as wood, bamboo, hemp, jute, kenaf, cotton, beet, agricultural product residual wastes, cloth, or the like. Also, waste paper such as waste newspaper, cardboard waste paper, magazine waste paper, copy paper waste paper, or the like can be used as the raw material of the cellulose fibers. For example, Sitka spruce, cedar, cypress, eucalyptus, acacia, or the like can be used as wood. These raw materials can be used alone or in combination of two or more selected from the raw materials.

The raw material of the cellulose fibers is preferably a pulp or a fibrillated cellulose produced by fibrillating pulp. The pulp is preferably chemical pulp (kraft pulp (KP) or sulfite pulp (SP)), semi-chemical pulp (SCP), chemiground pulp (CGP), chemimechanical pulp (CMP), groundwood pulp (GP), refiner mechanical pulp (RMP), thermomechanical pulp (TMP), or chemithermomechanical pulp (CTMP), which can be produced by chemical or mechanical pulping or combination of chemical and mechanical pulping of the plant raw material. Also, de-inked waste paper pulp, cardboard waste paper pulp, or magazine water paper pulp, which contains the pulp described above as a main component, may be used.

The average fiber length of the cellulose fiber raw material used in the present invention is preferably 0.5 mm or more and more preferably 2.5 mm or more. With the longer fiber length, the aspect ratio of fibrillated CNF in the resin is increased, and thus the reinforcement effect can be increased.

The upper limit of freeness of the cellulose fiber raw material is preferably 720 cc and more preferably 540 cc. The lower limit of freeness is preferably 15 cc and more preferably 30 cc. With the freeness within the range, the cellulose fibers can be easily fibrillated in the resin, and the reinforcement effect can be increased.

Further, the pulp is preferably any one of various types of kraft pulps derived from needle-leaf trees and having high fiber strength (needle-leaf unbleached kraft pulp (NUKP), needle-leaf oxygen-bleached kraft pulp (NOKP), and needle-leaf bleached kraft pulp (NBKP)), and the like. In addition, broadleaf kraft pulp (bleached kraft pulp (LBKP), unbleached kraft pulp (LUKP), oxygen-bleached kraft pulp (LOKP)), or the like may be used.

If required, the lignin amount in the pulp used as the raw material of the cellulose fibers may be adjusted by delignification, bleaching, or the like. The pulp is mainly composed of cellulose, hemicellulose, and lignin. The lignin content in the pulp is not particularly limited. The lignin content in the pulp is about 0% by weight to 40% by weight and preferably about 0% by weight to 10% by weight. The lignin content can be measured by the Klason method.

Microfibrillated cellulose (MFC) of about 4 nm in width are present as the minimum unit in plant cell walls. This is a basic skeleton material (basic element) of plants. The MFC gather to form a skeleton of a plant.

The cellulose fibers are assembled fibers containing lignocellulose, MFC, CNF, pulp, wood powder, and the like.

In addition, cellulose nanofibers (CNF) can be used as the cellulose fibers contained in the resin composition of the present invention. CNF represents plant fibers produced by loosening (fibrillating), to the nano-level size, the fibers of a material (for example, the plant raw material such as wood pulp or the like) containing cellulose fibers. CNF refers to plant fibers having a light weight and high strength as compared with steel and having less thermal deformation than glass.

CNF refers to fibers produced by treatment such as mechanical fibrillation or the like of cellulose fibers, and the fibers have a fiber diameter (fiber width) (average value) of about 4 nm to 200 nm and a fiber length (average value) of about 5 μm or more.

The fiber diameter of CNF is preferably about 4 nm to 150 nm and more preferably about 4 nm to 100 nm.

The fiber length of CNF is preferably about 5 μm to 100 μm

Each of the fiber diameter (average value) and fiber length (average value) of CNF can be represented by, for example, an average value obtained by measurement of at least 50 or more CNF fibers in the field of view of an electron microscope.

The specific surface area of CNF is preferably about 70 m²/g to 300 m²/g, more preferably about 70 m²/g to 250 m²/g, and still more preferably about 100 m²/g to 200 m²/g.

When a composition is prepared by combining with a resin, increasing the specific surface area of CNF can increase the contact area with the resin and thus can improve the strength of the resin composition. Aggregation of CNF in the resin of the resin composition can be suppressed by adjusting the specific surface area of CNF, and thus the resin composite material having high strength can be prepared.

CNF can be prepared by fibrillating the cellulose fibers of pulp or the like. A fibrillation method includes first preparing a water suspension or a slurry of the cellulose fibers. Next, the cellulose fibers are fibrillated by mechanically grinding or beating the water suspension or slurry by using a refiner, a high-pressure homogenizer, a grinder, a kneader (extruder), a bead mill, or the like, thereby preparing CNF.

Alternatively, CNF can be prepared by chemical treatment of pulp and a relatively light mechanical beating operation. These fibrillation methods can be used alone or in combination of two or more.

In addition, a single-screw or multi-screw kneader is preferably used, and a double-screw kneader is preferably used as the kneader (extruder).

The cellulose fibers and CNF preferably have a cellulose I-type crystal. The degree of crystallization is preferably 50% or more, more preferably 55% or more, and still more preferably 60% or more. The upper limit of the degree of cellulose I-type crystallization of cellulose fibers and CNF is generally about 90%.

When the cellulose fibers and CNF have a cellulose I-type crystal structure, the crystalline elastic modulus is increased. When CNF (or cellulose fibers) has a I-type crystal structure, the resin composition or composite resin material containing CNF (or the cellulose fibers) and the resin (matrix material) becomes a composite resin material having a low coefficient of linear thermal expansion and a high elastic modulus. The CNF (or the cellulose fibers) having a I-type crystal structure can be identified by having typical peaks at two positions near 2θ=14° to 17° and near 2θ=22° to 23° in the diffraction profile obtained by measurement of a wide-angle X-ray diffraction image.

In the case of natural cellulose, the degree of polymerization of cellulose is about 500 to 10,000. The cellulose fibers form a crystal with an extended chain, in which some bundles of cellulose linearly extended by β-1,4-bonding are fixed by intramolecular or intermolecular hydrogen bond. Natural cellulose has an I-type crystal form. Due to the extended chain crystal, the cellulose fibers (or CNF) are plant fibers having not only a high elastic modulus but also a lighter weight and higher strength than steel and less thermal deformation than glass.

When the resin composition of the present invention contains CNF as the cellulose fibers, CNF is satisfactorily dispersed in the resin by the fibrillation aid, thereby improving the bonding as a reinforcement material with the resin.

(1-2) Fibrillation Aid

The resin composition of the present invention is prepared by adding the fibrillation aid and the resin such as a high-density polyethylene or the like to the cellulose fibers such as wood-derived pulp or the like, thereby preparing a mixture (premix). The cellulose fibers can be fibrillated to the nano-level by melt-kneading the mixture by using a double-screw kneader (double-screw extruder) or the like.

However, the time to add the fibrillation aid does not matter.

The fibrillation aid can be mixed with the mixture (premix) in a dry state, which contains the cellulose fibers and the resin, by adding at the time of beating the pulp or adding to water containing the pulp.

As a result, the composite resin material containing CNF and exhibiting high mechanical properties can be prepared. The resin composition of the present invention contains the fibrillation aid, thereby causing, in the resin composition, the simultaneous proceeding of preparation of CNF (fibrillation of the cellulose fibers), dispersion of CNF in the resin, and compounding of CNF with the resin. The fibrillation aid is preferably a material having a functional polar group interacting with cellulose and hemicellulose, for example, such as an ester bond, an ether bond, an amide bond, a urea bond, or the like. Also, the fibrillation aid is preferably a material having a hydrogen-bonding functional group such as a hydroxyl group, an amino group, or the like.

The fibrillation aid is more preferably a material having both the polarity, which interacts with cellulose and hemicellulose, and the hydrogen-bonding functional group.

Further, the fibrillation aid is desirably a material which is liquid under kneading conditions.

Hereinafter, “mp” represents a melting point.

The melting point of the fibrillation aid is its solid-liquid transition temperature. The decomposition temperature of the fibrillation aid is, for example, the temperature at which urea is converted into biuret (urea dimer) and ammonia by decomposition. When reaching the melting temperature by high-temperature treatment, the fibrillation aid melts out, and when reaching the decomposition temperature by further high-temperature treatment, the fibrillation aid starts to be decomposed.

The melting temperature of the fibrillation aid is preferably equal to or lower than the kneading temperature, and the decomposition temperature is preferably equal to or higher than the kneading temperature (processing temperature).

Because the fibrillation aid is required to be melted during kneading, the melting temperature of the fibrillation aid is preferably equal to or lower than the temperature at which the resin (polyethylene or the like) is kneaded by a kneader (extruder) (manufactured by Xplore Instruments BV). On the other hand, the fibrillation aid is preferably solid at room temperature.

Also, the decomposition temperature of the fibrillation aid is preferably equal to or higher than the kneading temperature.

Urea and Urea Derivative

The fibrillation aid is particularly preferably at least one component selected from the group consisting of urea (NH₂—CO—NH₂) (mp: 133° C. to 135° C.), biuret (H₂N—CO—NH—CO—NH₂) (mp: 186° C. to 189° C.), biurea (H₂N—CO—NH—NH—CO—NH₂) (mp: 247° C. to 250° C.), and hydrazide.

The hydrazide used as the fibrillation aid is preferably at least one component selected from the group consisting of 4-aminobenzohydrazide (mp: 226° C. to 230° C.), 2-aminobenzoyl hydrazide (mp: 122° C. to 125° C.), azelaic acid dihydrazide (mp: 182° C. to 187° C.), carbohydrazide (mp: 153° C. to 157° C.), isophthalic acid dihydrazide (mp: 227° C.), oxalyl dihydrazide (mp: 242° C. to 244° C.), oxamic acid hydrazide, adipic acid dihydrazide (mp: 179° C. to 184° C.), sebacic acid dihydrazide (mp: 186° C.), dodecanedioic acid dihydrazide (mp: 186° C. to 191° C.), isophthalic acid dihydrazide (mp: 227° C.), terephthalic acid dihydrazide, and succinic acid dihydrazide (mp: 168° C.)

Decomposition of the fibrillation aid produces the decomposed product of the fibrillation aid, which can serve as another fibrillation aid.

For example, it is known that the melting point of urea is about 133° C. and urea is gradually decomposed after melting, and decomposition of urea produces isocyanic acid by the release of ammonia molecules. The acid is considered to produce biuret by reaction with another urea molecule. On the other hand, isocyanic acid forms a carbamate by reaction with the surfaces of cellulose fibers.

Therefore, urea or a urea derivative is preferably used as the fibrillation aid, and urea and biuret can be more preferably used.

Also, biurea (soluble in hot water) having a molecular structure similar to urea and biuret and a melting point of about 250° C. can be preferably used as the fibrillation aid.

Further, based on the molecular structures of urea, biuret, and biurea, hydrazides (adipic acid dihydrazide, sebacic acid dihydrazide, and the like) can also be preferably used.

Urea derivatives are compounds capable of substituting hydrogen (atoms) of urea (NH₂—CO—NH₂) (Organic and Biochemical Nomenclature, 2nd revised edition, Nankodo, 1988). A compound (ureide compound) having NH₂—CO—NH— and a compound (ureylene compound) having —NH—CO—NH— can be used as urea derivatives.

Usable examples of the urea derivatives include N,N′-dimethylurea (1,3-dimethylurea) (mp: 102° C. to 108° C.), N,N′-diethylurea (1,3-diethylurea) (mp: 110° C. to 113° C.), N,N′-bis(hydroxymethyl)urea (mp: 125° C.), N,N′-bis(trimethylsilyl)urea (mp: 219° C. to 221° C.), N,N′-trimethyleneurea (mp: 263° C. to 267° C.), N-phenylurea (mp: 145° C. to 147° C.), N,N′-dicyclohexylurea (mp: 232° C. to 233° C.), N,N′-phenylurea (1,3-diphenylurea) (mp: 239° C. to 241° C.), barbituric acid (mp: 248° C. to 252° C.), hydantoin acid (mp: 220° C.), 2-imidazolidone (ethyleneurea, 2-imidazolidinone) (mp: 129° C. to 132° C.), cyanuric acid (mp: >360° C.), and the like.

Also, isourea (HN═C(OH)—NH₂), a compound (1-isoureide compound) having HN═C(OH)—NH—, and a compound (3-isoureide compound) having —N═C(OH)—NH₂ can be used as urea derivatives.

Further, a compound which can be produced by substituting oxygen (atom) of urea, isourea, and derivatives thereof with an amine or sulfur (atom) can be used. Usable examples thereof include thiourea (NH₂—CS—NH₂) (mp: 170° C. to 176° C.), N-methylthiourea (mp: 118° C. to 121° C.), N-ethylthiourea (mp: 108° C. to 110° C.), N-allylthiourea (mp: 70° C. to 72° C.), N-phenylthiourea (mp: 145° C. to 150° C.), guanidine hydrochloride (mp: 180° C. to 185° C.), S-methylisothiourea hemisulfate salt (mp: 240° C. to 241° C.), O-methylisourea hemisulfate salt (mp: 163° C. to 167° C.), N,N′-dimethylthiourea, N,N′-diethylthiourea (mp: 76° C. to 78° C.), N,N′-diisopropylthiourea (mp: 143° C. to 145° C.), N,N′-diphenylthiourea (mp: 152° C. to 155° C.), 2-imidazolidine thione (mp: 196° C. to 200° C.), and the like.

A condensed product of urea can be used. Usable examples thereof include biuret (NH₂—CO—NH—CO—NH₂), 2-imino-4-thiobiuret (mp: 171° C. to 173° C.), and the like.

Also, semicarbazide, carbonohydrazide, carbazone, carbodiazone, and the like can be used as urea derivatives. Further, a compound (semicarbazide compound) having NH₂—CO—NH—NH— and a compound (carbazono compound) having NH═N—CO—NH—NH— can be used.

Further, 2,5-dithiobiurea (mp: 212° C.) can be used as a urea derivative.

Saccharide and Saccharide Alcohol

A saccharide is preferably used as the fibrillation aid, and a saccharide such as a monosaccharide, a disaccharide, or the like, a saccharide alcohol, a monosaccharide or disaccharide derivative, or the like is preferably used.

Usable examples of a monosaccharide include trioses such as ketotriose (1,3-dihydroxyacetone (mp: 75° C. to 80° C.) and the like), and aldotriose (DL-glyceraldehyde (mp: 145° C.) and the like).

Other usable examples include pentoses such as ketopentose (ribulose, xylulose, and the like), aldopentose (arabinose (L-(+)-arabinose) (mp: 160° C. to 163° C.), xylose (D-(+)-xylose) (mp: 144° C. to 145° C.), and the like), and deoxysaccharides (deoxyribose (mp: 91° C.)).

Other usable examples include hexoses such as ketohexose (fructose (D-(−)-fructose) (fruit saccharide) (mp: 104° C.) and the like), aldohexose (glucose (D(+)-glucose) (mp: 146° C. to 150° C.), mannose (D-(+)-mannose) (mp: 132° C. to 133° C.), and the like), deoxysaccharides (ramnose (L-(+)-ramnose monohydrate) (mp: 91° C. to 93° C.) and the like).

Further usable examples include disaccharides such as sucrose (mp: 186° C.), maltose (maltose monohydrate (malt saccharide)) (mp: 160° C. to 165° C.), trehalose (D-(+)-trehalose dihydrate) (mp: 203° C.), cellobiose (D-(+)-cellobiose, mp: 239° C.), and the like.

Other usable examples include uronic acid (glucuronic acid (D(+)-glucuronic acid) (mp: 159° C. to 161° C.) and the like), amino saccharide (N-acetyl-D-glucosamine (mp: 211° C.) and the like), saccharide alcohols (sorbitol (D-glucitol) (mp: 95° C.), xylitol (mp: 92° C. to 96° C.), and the like), and the like.

Also, glycerin (mp: 17.8° C.) can be used as a saccharide alcohol.

Other usable examples include saccharide derivatives (β-D-glucose pentaacetate (mp: 130° C. to 132° C.), α-D(+)-glucose pentaacetate (mp: 109° C. to 111° C.), and the like), which are produced by reacting the hydroxyl groups of the saccharide compounds.

Organic Acid and Salt Thereof (Organic Acid Salt)

An organic acid or a salt thereof (organic acid salt) is preferably used as the fibrillation aid.

Usable examples thereof include sodium formate (mp: 253° C.), ammonium formate (mp: 116° C.), sodium acetate (mp: 324° C.), ammonium acetate (mp: 112° C.), sodium citrate (mp: 300° C. or more), triammonium citrate (mp: 185° C.), sodium oxalate (mp: decomposed at 250° C. to 270° C.), ammonium oxalate (mp: anhydride at 65° C.), and the like.

The fibrillation aids may be used alone or in combination or two or more fibrillation aids.

That is, at least one fibrillation aid selected from the group consisting of the compounds described above can be used. The resin composition of the present invention uses the fibrillation aid, and thus the cellulose fibers (preferably CNF) are satisfactorily dispersed in the resin.

(1-3) Resin

The resin component contained in the resin composition of the present invention is preferably a thermoplastic resin, a thermosetting resin, or the like.

In view of the advantage that a composite resin material can be satisfactorily molded, a thermoplastic resin is preferably used as the resin. Preferred examples of the thermoplastic resin include general-purpose resins such as an olefin resins, polyvinyl chloride, polystyrene, a methacrylic resin, an ABS resin, and the like; general-purpose engineering plastics such as a nylon resin, polyamide resin (PA), a polycarbonate resin, a polysulfone resin, a polyester resin, and the like; cellulose resins such as triacetylated cellulose, diacetylated cellulose, and the like; and the like.

In view of the advantage that the reinforcing effect can be satisfactorily obtained when the resin composition is produced and the advantage of being low cost, the olefin resin or the like is preferred as the thermoplastic resin. The olefin resin is preferably a polyethylene resin (PE), a polypropylene resin (PP), or the like.

In view of the advantage that the reinforcing effect can be satisfactorily obtained when the resin composition is produced and the advantage of being low cost, the olefin resin is preferably PE or PP, such as high-density polyethylene (HDPE), low-density polyethylene (LDPE), biopolyethylene, or the like.

PA is preferably polyamide 6 (PA6, ring-opened polymer of ϵ-caprolactam), polyamide 66 (PA66, polyhexamethylene adipamide), polyamide 11 (PA11, polyamide produced by ring-opening polycondensation of undecanelactam), polyamide 12 (PA12, PA produced by ring-opening polycondensation of lauryllactam), or the like.

Preferred examples of the thermosetting resin include an epoxy resin, a phenol resin, a urea resin, a melamine resin, an unsaturated polyester resin, a diallyl phthalate resin, a polyurethane resin, a silicone resin, a polyimide resin, and the like.

When an epoxy resin is used, a curing agent is preferably used. By mixing the curing agent, a molding material produced from the resin composition can be more strongly molded, thereby improving mechanical strength.

These resins may be used alone or as a mixed resin of two or more.

Examples which may be combined as a compatibilizer include a resin such as a maleic anhydride-modified polyethylene resin (PE) or maleic anhydride-modified polypropylene resin (PP), in which a polar group is introduced by adding maleic anhydride, epoxy, or the like to a thermoplastic resin or thermosetting resin, and various commercial compatibilizers. The compatibilizers may be used alone or in combination of two or more.

When a mixed resin including a combination of a maleic anhydride-modified resin and another polyolefin resin is used, the content ratio of the maleic anhydride-modified resin is preferably about 1% to 40% by mass and more preferably about 1% to 20% by mass in the polyolefin resin. Preferred examples of the mixed resin include a mixed resin of maleic anhydride-modified PP and PE and/or PP, a mixed resin of maleic anhydride-modified PE and PE and/or PP, and the like.

The resin composition of the present invention contains the cellulose fibers (preferably CNF) satisfactorily dispersed in the resin by the fibrillation aid.

(1-4) Dispersant

The resin composition of the present invention preferably further contains a dispersant. The dispersant is preferably a component having a resin-affinitive segment and a cellulose-affinitive segment and having a block copolymer structure or gradient copolymer structure.

The resin composite material of the present invention is prepared by adding the fibrillation aid and the dispersant (preferably a water-soluble dispersant or polymer dispersant) to the pulp to prepare a mixture (premix). The wood-derived pulp treated with the dispersant is used as a raw material, and the pulp is fibrillated to the nano-level by melt-kneading the mixture by using a double-screw extruder or the like. As a result, the composite resin material containing CNF and exhibiting higher mechanical properties can be produced.

The block copolymer structure represents a structure (for example, A-B, A-B-A, A-B-C, or the like) in which two or more polymer chains A, B, C . . . having different properties (for example, polarities or the like) are linearly bonded to each other. An example thereof is an A-B type block copolymer structure such that a polymer chain A and a polymer chain B are linearly bonded to each other. The block copolymer structure can be produced by using known living polymerization.

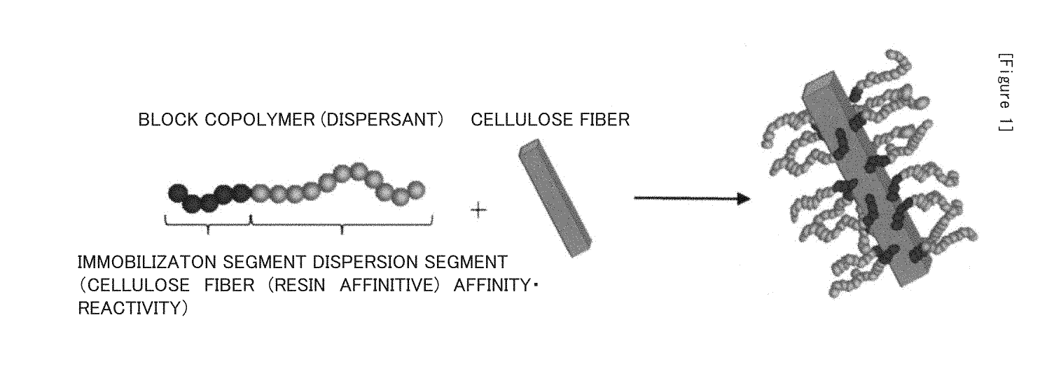

The dispersant is preferably an A-B type diblock copolymer having a resin-affinitive segment A and a cellulose-affinitive segment B. FIG. 1 shows the outlines of a polymer dispersant.

The monomer unit constituting the resin-affinitive segment A and the cellulose-affinitive segment B is preferably a vinyl monomer unit, and more preferably contains at least one monomer unit selected from the group consisting of a (meth)acrylate monomer, a (meth)acryl amide monomer, and a styrene monomer.

The gradient copolymer structure represents a structure in which, for example, in a copolymer having repeating units derived from two types of monomers A and B having different properties (for example, polarities or the like), the repeating units have such a distribution gradient that the ratio of the A unit decreases from an end rich of the A unit in the polymer chain to the other end rich of the B unit, while the ratio of the B unit decreases. The gradient copolymer structure can be produced by using known living polymerization.

The surfaces of the cellulose fibers have hydroxyl groups and are thus effectively coated with the cellulose-affinitive segment B of the A-B type diblock copolymer or A-B type gradient copolymer. Also, the surfaces of the cellulose fibers are hydrophobilized with the resin-affinitive segment A of the A-B type diblock copolymer or A-B type gradient copolymer.

The cellulose fibers can be mixed and dispersed even with hydrophobic fibers basically having low affinity by using the dispersant under the mild conditions of room temperature and normal pressure.

Thus, the hydrophobilized cellulose fibers are uniformly dispersed even in a thermoplastic resin having very high hydrophobicity, such as polyethylene (PE), polypropylene (PP), or the like. The dispersant can improve interfacial strength between the cellulose fibers and the resin and can suppress the aggregation of the cellulose fibers in the resin. As a result, the composite material and molded product having excellent strength and elastic modulus can be produced.

Resin-Affinitive Segment A

The resin-affinitive segment A hydrophobilizes the cellulose surfaces through the cellulose-affinitive segment B. The basis for resin-affinity lies in the similarity to the structure of a resin as an object and in the necessity of having hydrophobicity close to that of a resin as an object.

The monomer unit constituting the resin-affinitive segment A preferably contains at least one monomer unit selected from the group consisting of a (meth)acrylate monomer, a (meth)acrylamide monomer, and a styrene monomer.

The resin-affinitive segment A is preferably a repeating unit composed of a monomer component such as lauryl methacrylate (LMA), synthetic lauryl methacrylate (SLMA), 4-tert-butylcyclohexyl methacrylate (tBCHMA), cyclohexyl methacrylate (CHMA), methyl methacrylate (MMA), ethyl methacrylate (EMA), butyl methacrylate (BMA), hexyl methacrylate (HMA), 2-ethylhexyl methacrylate (EHMA), benzyl methacrylate (BnMA), isobornyl methacrylate (IBOMA), dicyclopentenyloxyethyl methacrylate (DCPOEMA), dicyclopentanyl methacrylate (DCPMA), or the like.

An alicyclic compound such as DCPOEMA or the lie is particularly preferably used.

Preferably usable examples of the monomer component of the resin-affinitive segment A include a (meth)acrylate monomer having a CₙH₂ₙ₊₁ group or a branched alkyl group as a side chain, such as MMA, LMA, and the like; a (meth)acrylate monomer having a combination of alkyl groups having different numbers of carbon atoms; a (meth)acrylate monomer having an unsaturated alkyl group; and the like.

These monomer components of the resin-affinitive segment A can be used alone or in combination of two or more.

The chemical structures and abbreviations of preferred examples of the repeating unit (monomer component) constituting the resin-affinitive segment A are described below.

Hereinafter, (a) represents a repeating unit of the resin-affinitive segment A.

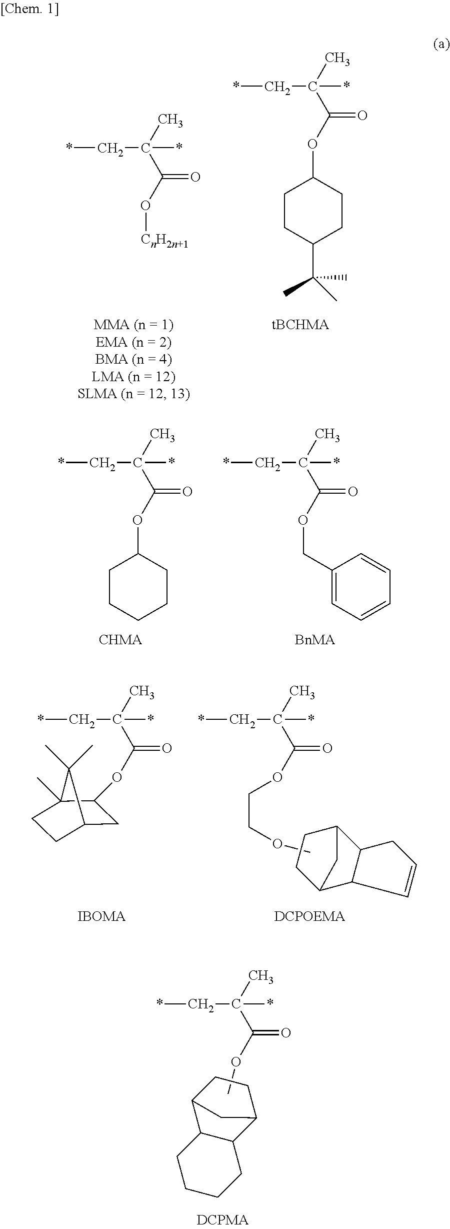

Table 1 shows preferred forms of the resin-affinitive segment A.

TABLE 1
Preferred form of resin-affinitive segment A

| Monomer | | | |
|---|---|---|---|
| component | | | |
| constituting | Number-average | Molecular weight | Number-average |
| resin-affinitive | molecular weight | distribution | polymerization |
| segment A | (Mn) | index (Mw/Mn) | degree (DPn) |
| LMA | 4,900-10,000 | 1.31 | 19-39 |
| tBCHMA | 4,000-8,000 | 1.28-1.36 | 18-36 |
| MMA | 6,610 | 1.35 | 66 |
| CHMA | 4,350-4,820 | 1.31-1.52 | 26-29 |
| IBOMA | 2,380-4,220 | 1.19-1.38 | 11-19 |
| DCPOEMA | 3,300-6,730 | 1.13-1.43 | 13-30 |
| DCPMA | 4,050 | 1.43 | 17 |
| SLMA | 7,000-8,000 | 1.20-1.38 | 29-32 |
| BnMA | 3,500-4,600 | 1.11-1.19 | 20-33 |

According to gel permeation chromatography of the resin-affinitive segment A, the number-average molecular weight in terms of polystyrene is preferably about 500 to 20,000, more preferably about 500 to 15,000, and still more preferably about 1,000 to 10,000.

In order that the resin-affinitive segment A exhibits resin-affinity with a resin (compatibility with a resin), the number-average molecular weight is preferably about 1,000 to 10,000.

The number-average polymerization degree (average number of repeating units) of the resin-affinitive segment A is preferably about 1 to 200, more preferably about 5 to 100, and still more preferably about 10 to 50.

The monomer unit constituting the resin-affinitive segment A preferably includes a monomer unit selected from the hydrophobic monomer group of a (meth)acrylate monomer, a styrene monomer, and the like.

Cellulose-Affinitive Segment B

The cellulose-affinitive segment B shows intermolecular interaction, including interaction by a hydrogen bond, with the surfaces of the cellulose fibers. In the dispersant, the cellulose-affinitive segment B having many hydroxyl groups forms multipoint hydrogen bonds with the cellulose fibers due to the polymer effect and thus sufficiently adsorbs to the cellulose surfaces, but slightly desorbs therefrom.

It is known that the surfaces of cellulose fibers show minus zeta potential, and a material containing cellulose fibers contains hemicellulose (partially containing a unit with negative charge, such as glucuronic acid or the like). Therefore, the cellulose-affinitive segment B having many cationic functional groups, for example, quaternary ammonium salts or the like, is satisfactorily adsorbed to the cellulose fibers.

The monomer unit constituting the cellulose-affinitive segment B preferably contains at least one monomer unit selected from the group consisting of a (meth)acrylate monomer, a (meth)acrylamide monomer, and a styrene monomer.

In view of the point that hydrogen bonding to cellulose is exhibited, the cellulose-affinitive segment B is preferably a segment having a hydroxyl group (HEMA, a saccharide residue, or the like), a carboxylic acid, an amide (urea, urethane, amizine, or the like), or a cationic part (quaternary ammonium salt or the like).

Among the preferred examples of the repeating unit (monomer component) constituting the cellulose-affinitive segment B, preferred examples of the monomer with hydrogen-bonding to cellulose include 2-hydroxyethyl methacrylate (HEMA), benzylated dimethyl aminoethyl methacrylate (quaternized dimethyl aminoethyl methacrylate: QDEMAEMA), [2-(methacryloyloxy)ethyl]trimethylammonium iodide (DMAEMA-Me⁺I⁻), and the like.

A segment having a functional group, for example, an isocyanate group, an alkoxysilyl group, a boric acid, or a glycidyl group, can be preferably used as the monomer component of the cellulose-affinitive segment B in view of the fact that the functional group is reactable with hydroxyl groups of cellulose.

Preferably usable examples of the monomer component of the cellulose-affinitive segment B include hydroxyl group-containing (meth)acrylates such as 2-hydroxyethyl (meth)acrylate, 2-hydroxypropyl (meth)acrylate, 3-hydroxypropyl (meth)acrylate, and the like; polyalkylene glycol mono(meth)acrylates such as polyethylene glycol mono(meth)acrylate, polypropylene glycol mono(meth)acrylate, and the like; glycol ester-based (meth)acrylates such as (poly)ethylene glycol monomethyl ether (meth)acrylate, (poly)ethylene glycol monoethyl ether (meth)acrylate, (poly)propylene glycol monomethyl ether (meth)acrylate, and the like; and the like.

Both “poly” and “(poly)” represent n=2 or more.

These monomer components of the cellulose-affinitive segment B can be used alone or in combination of two or more.

The chemical structures and abbreviations of preferred examples of the repeating unit (monomer component) constituting the cellulose-affinitive segment B are described below.

Hereinafter, (b) represents the repeating unit of the cellulose-affinitive segment B, which has interaction.

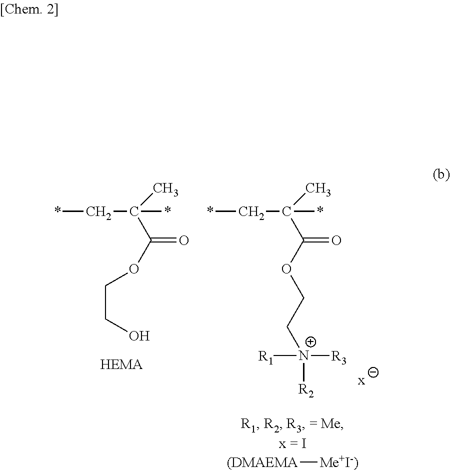

Table 2 shows preferred forms of the cellulose-affinitive segment B.

TABLE 2
Preferred form of cellulose-affinitive segment B

| Monomer component | | |
|---|---|---|
| constituting | Number-average | Number-average |
| cellulose-affinitive | molecular | polymerization |
| segment B | weight (Mn) | degree (DPn) |
| HEMA | 2,000-4,000 | 16-29 |
| DMAEMA-Me⁺I⁻ | 9,000-10,000 | 31-33 |

In order to make the polymer dispersant water-soluble, the cellulose-affinitive segment B is preferably a segment containing [2-(methacryloyloxy)ethyl]trimethylammonium iodide or chloride (DMAEMA-Me⁺I⁻) of a quaternary ammonium salt type.

According to gel permeation chromatography of the cellulose-affinitive segment B, the number-average molecular weight in terms of polystyrene is preferably about 500 to 20,000, more preferably about 500 to 15,000, and still more preferably about 1,000 to 10,000. This is a molecular weight region in which the cellulose-affinitive segment B is considered to have the highest efficiency of adsorption.

In order that the cellulose-affinitive segment B exhibits multipoint interaction with cellulose, the number-average molecular weight is preferably about 1,000 to 10,000.

The number-average polymerization degree (average number of repeating units) of the affinity-affinity segment B is preferably about 1 to 200, more preferably about 5 to 100, and still more preferably about 10 to 50. This is a molecular weight region in which the cellulose-affinitive segment B is considered to have the highest efficiency of adsorption.

In order that the cellulose-affinitive segment B exhibits multipoint interaction with cellulose, the cellulose-affinitive segment B preferably contains at least a decamer.

Dispersant

The dispersant is preferably synthesized by a living polymerization method and more preferably synthesized by a living radical polymerization method.

The dispersant is preferably a vinyl polymer. The dispersant is particularly preferably composed of at least one monomer unit selected from the group consisting of a (meth)acrylate monomer, a (meth)acrylamide monomer, and a styrene monomer.

Also, a segment produced by a method other than the living radical polymerization method can be used as each of the resin-affinitive segment A and the cellulose-affinitive segment B. Preferably usable examples of the resin-affinitive segment A include an oligoethylene chain, an oligopropylene chain, polylactic acid, and the like.

The cellulose-affinitive segment B is preferably polyoxyethylene (PEO), oligosaccharide, or the like. In this case, it is preferred that one of the segments is synthesized by the living radical polymerization method, and an existing polymer, oligomer, or the like is used as the other block.

The basic design of the dispersant has the resin-affinitive segment A and the cellulose-affinitive segment B, and thus an A-B diblock copolymer or an A-B gradient copolymer is preferred.

The ratio of the resin-affinitive segment A in the whole dispersant is preferably about 5% by mass to 95% by mass, more preferably about 20% by mass to 95% by mass, and still more preferably about 40% by mass to 70% by mass.

The ratio of the cellulose-affinitive segment B in the whole dispersant is preferably about 5% by mass to 95% by mass, more preferably about 5% by mass to 60% by mass, and still more preferably about 10% by mass to 50% by mass.

With the low ratio of the cellulose-affinitive segment B, the function of coating cellulose is weakened. While when the cellulose-affinitive segment B has a high number-average molecular weight or a high ratio in the whole, lower solubility or adsorption between cellulose particles may occurs, thereby causing a defect in micro-particle dispersion.

The length of each of the resin-affinitive segment A and the cellulose-affinitive segment B is preferably about 1 nm to 100 nm over the dispersant, which is the length of a relatively medium-molecular-weight polymer. The length is more preferably about 1 nm to 50 nm and still more preferably about 1 nm to 10 nm.

According to gel permeation chromatography of the dispersant, the number-average molecular weight in terms of polystyrene is preferably about 200 to 40,000, more preferably about 1,000 to 20,000, and still more preferably about 2,000 to 10,000. The low molecular weight may cause a decrease in physical properties of a product.

Solubility tends to be decreased due to the high molecular weight and, for example, when a cellulose dispersion is prepared by using the dispersant, the performance of easily dispersing cellulose, which is the significant effect of the present invention, may be impaired.

The molecular weight distribution index (weight-average molecular weight/number-average molecular weight) of the dispersant is preferably about 1.0 to 1.6, more preferably about 1.0 to 1.5, and still more preferably about 1.0 to 1.4.

The molecular weight distribution index (weight-average molecular weight/number-average molecular weight) of the dispersant indicates the degree of molecular weight distribution, and a lower value represents a narrow molecular weight distribution of the dispersant, that is, high uniformity of the molecular weight. The narrow molecular weight distribution represents that the dispersant has a low ratio of high molecular weight or low molecular weight and has uniform properties, thereby decreasing a decrease in solubility in the case of a high molecular weight and decreasing an influence on an article in the case of a low molecular weight. As a result, the effect of imparting a high degree of micro-dispersion by the dispersant can be improved.

Table 3 shows preferred forms of the dispersant.

TABLE 3
Preferred from of dispersant

| Overall number-average | Overall number-average |
|---|---|
| molecular weight Mn | polymerization degree Mw/Mn |
| 4,480-11,300 | 1.20-1.6 |

The dispersant is preferably an A-B type block copolymer including the resin-affinitive segment A and the cellulose-affinitive segment B.

The block copolymer is preferably designed and synthesized by living radical polymerization (LRP), and a vinyl polymer produced by living radical polymerization is preferred.

The block copolymer is preferably added, to water containing cellulose, in the state of an aqueous solution or a state of being dissolved in a water-soluble mixed solvent (water and isopropanol).

When cellulose is mixed with the resin (PE or the like), aggregation of cellulose can be suppressed by adding the block copolymer during melt-kneading. Also, the strength of the resin composition (molding material or molded product) can be enhanced by adding the block copolymer of the present invention to water containing cellulose and the resin (PE or the like) in the step of fibrillating cellulose.

The dispersant preferably has a gradient copolymer structure formed of the resin-affinitive segment A and the cellulose-affinitive segment B. In the gradient copolymer structure including the resin-affinitive segment A and the cellulose-affinitive segment B, a monomer a constituting the resin-affinitive segment A and a monomer b constituting the cellulose-affinitive segment B are two types of monomers a and b having different polarities.

The gradient copolymer structure is preferably a structure in which the repeating units have such a distribution gradient that the ratio of the monomer a decreases from an end rich of the monomer a in the polymer chain to the other end rich of the monomer b, while the ratio of the monomer b increases.

Method for Producing Dispersant

A monomer (for example, tBCHMA or the like) used for the resin-affinitive segment A is dissolved in an amphipathic solvent (for example propylene glycol, monopropyl ether, or the like) and subjected to living radical polymerization (LRP) in the presence of a catalyst. Then, a predetermined time after, a monomer (for example, HEMA or the like) used for the cellulose-affinitive segment B is added to synthesize a block copolymer. After the preparation of a bock copolymer solution, hydrous methanol is added dropwise to precipitate a solid. Thus, the catalyst and residual monomers can be removed.

The resultant solid (block copolymer or gradient copolymer) is dissolved in a solvent and then re-precipitated and purified by being added dropwise to a poor solvent (for example, acetone or the like).

LRP represents a polymerization reaction in which chain transfer reaction and termination reaction do not substantially take place in radical polymerization reaction, and activity is maintained at the chain growth end after the completion of monomer reaction. In this polymerization reaction, polymerization activity is maintained at an end of the produced polymer even after the completion of polymerization reaction, and polymerization reaction can be again initiated by adding a monomer.

LRP is characterized in that a polymer having a desired average molecular weight can be synthesized by adjusting the concentration ratio of a monomer to a polymerization initiator, in that the produced polymer has a very narrow molecular weight distribution, in that it can be applied to synthesis of a block copolymer, etc. The living radical polymerization may be abbreviated as “LRP” or referred to as “controlled radical polymerization”.

The polymerization method of the present invention uses the radical polymerizable monomers described above. The radical polymerizable monomers refer to monomers each having an unsaturated bond capable of radical polymerization in the presence of organic radical. The unsaturated bond is preferably a double bond. That is, the polymerization method of the present invention can use any desired monomers which have been known to be capable of LRP.

The LRP method can be applied to homopolymerization, that is, production of a homopolymer, and can produce a copolymer by copolymerization. The resin-affinitive segment A or the cellulose-affinitive segment B may be a random copolymer.

The block copolymer may be a copolymer in which two or more types of blocks are bonded or a copolymer in which three or more types of blocks are bonded.

In the case of the block copolymer having two or more types of blocks, the block copolymer can be produced by, for example, a method including a step of polymerizing a first block and a step of polymerizing a second block.

In this case, the LRP method may be used in the step of polymerizing the first block or the LRP method may be used in the step of producing the second block. The LRP method is preferably used in both the step of polymerizing the first block and the step of producing the second block.

The block copolymer can be produced by polymerizing the first block and then polymerizing the second block in the presence of the resultant first polymer. The first block can be isolated and purified and then supplied to polymerization of the second block, or the second monomer can be added to the first polymer, without being isolated and purified, during or at the completion of polymerization of the first polymer, thereby producing the block copolymer.

Like in the production of the copolymer having two or more types of blocks bonded to each other, in the production of the block copolymer having three types of blocks, a desired copolymer can be produced by a step of polymerizing each of the blocks.

The dispersant has the resin-affinitive segment A and the cellulose-affinitive segment B and has the block copolymer structure or gradient copolymer structure. The resin-affinitive segment A is a hydrophobic part and thus can also be referred to as the “dispersion segment”.

The cellulose-affinitive segment B is a hydrophilic part and thus can also be referred to as the “immobilization segment”. The dispersant is preferably an A-B type diblock copolymer and is preferably designed and synthesized by LRP.

The resin composition of the present invention contains the cellulose fibers (preferably CNF) which are satisfactorily dispersed in the resin by using the dispersant in addition to the fibrillation aid.

(1-5) Mixing Ratio of Resin Composition

The mixing ratio of each of the cellulose fibers, the fibrillation aid, the dispersant, and the resin in the resin composition may be such a content that the cellulose fibers can be dispersed.

The mixing ratio of the cellulose fibers in the resin composition is preferably about 0.1% by mass to 50% by mass, more preferably about 1% by mass to 20% by mass, and still more preferably about 5% by mass to 10% by mass.

The mixing ratio of the fibrillation aid in the resin composition is preferably about 0.01% by mass to 20% by mass, more preferably about 0.1% by mass to 10% by mass, and still more preferably about 0.1% by mass to 4% by mass.

The mixing ratio of the dispersant in the resin composition is preferably about 0.1% by mass to 20% by mass, more preferably about 0.1% by mass to 10% by mass, and still more preferably about 1% by mass to 6% by mass.

The mixing ratio of the resin in the resin composition is preferably about 10% by mass to 99.99% by mass, more preferably about 50% by mass to 99% by mass, and still more preferably about 80% by mass to 95% by mass.

The preparation of CNF, dispersion of CNF in the resin, and compounding of CNF and the resin can be simultaneously performed. This can produce a CNF-reinforced resin. The present invention permits the preparation of CNF and dispersion of CNF in the resin to be performed by a single operation, which is a simultaneous (SFC process) of nano-fibrillation and nano-dispersion.

As a result, the composite resin material containing CNF, which is satisfactorily dispersed in the resin, and exhibiting high mechanical properties can be produced.

(2) Method for Producing Resin Composition

In preparing the resin composition of the present invention, the time to add the fibrillation aid does not matter.

The fibrillation aid can be added at the time of beating the pulp or added to water containing the pulp, or can be mixed with the mixture (premix) containing the cellulose fibers and the resin.

The method for producing the resin composition containing the cellulose fibers, the fibrillation aid, and the resin includes, in order:

(1) a step of mixing the pulp with the resin; and

(2) a step of fibrillating the pulp by kneading the mixture prepared in the step (1) to produce a resin composition containing the cellulose fibers and the resin.

The preferred time of adding the fibrillation aid may be any one of the mixing step of the step (1), the kneading step of the step (2), and the fibrillation step of the step (2).

The fibrillation aid may be added in at least one of these steps or may be added in plural steps (at least one step).

The method for producing the resin composition containing the cellulose fibers, the fibrillation aid, and the resin preferably includes, in order:

(1) a step of mixing the pulp with the fibrillation aid and the resin (pre-addition of the fibrillation aid); and

(2) a step of fibrillating the pulp by kneading the mixture prepared in the step (1) to produce a resin composition containing the cellulose fibers, the fibrillation aid, and the resin.

The fibrillation aid is preferably added in the step (1) (pre-addition of the fibrillation aid) in view of the point that CNF is satisfactorily dispersed in the resin during fibrillation of the pulp in the next step (2).

The method for producing the resin composition containing the cellulose fibers, the fibrillation aid, and the resin preferably includes, in order:

(1) a step of mixing the pulp with the resin; and

(2) a step of adding the fibrillation aid to the mixture prepared in the step (1) and fibrillating the pulp by kneading the mixture to produce a resin composition containing the cellulose fibers, the fibrillation aid, and the resin (post-addition of the fibrillation aid).

The fibrillation aid is preferably added in the step (2) (post-addition of the fibrillation aid) in view of the point that CNF is satisfactorily dispersed in the resin during fibrillation of the pulp.

The method for producing the resin composition containing the cellulose fibers, the fibrillation aid, and the resin preferably includes, in order:

(1) a step of mixing the pulp with the fibrillation aid and the resin (pre-addition of the fibrillation aid); and

(2) a step of fibrillating the pulp by kneading the mixture prepared in the step (1) and further adding the fibrillation aid to the mixture to produce a resin composition containing the cellulose fibers, the fibrillation aid, and the resin (post-addition of the fibrillation aid).

The fibrillation aid is preferably added in both the step (1) and the step (2) (pre-addition of the fibrillation aid+post-addition of the fibrillation aid) in view of the point that CNF is satisfactorily dispersed in the resin during fibrillation of the pulp.

The preferred time of adding the fibrillation aid may be any one of the mixing step of the step (1), the kneading step of the step (2), and the fibrillation step of the step (2). The fibrillation aid may be added in at least one of these steps or may be added in plural steps (at least one step).

The cellulose fibers contained in the resin composition are preferably cellulose nanofibers (CNF).

Each of the components such as the cellulose fibers, the fibrillation aid, the dispersant, the resin, etc. can be used in each of the steps. The mixing ratio of each of the cellulose fibers, the fibrillation aid, the dispersant, the resin, etc. in the resin composition may be determined to be the content described above.

The resin composition (resin composite material) can be prepared by mixing the cellulose fibers with the resin by using the fibrillation aid and the dispersant. A characteristic is to add the fibrillation aid.

Examples of a method for mixing the cellulose fibers with the resin component (and any desired additive) include a method of kneading by using a kneading machine such as a kneading machine (extruder), a bench roller, a Banbury mixer, a kneader, a planetary mixer, or the like, a method of mixing by using a stirring blade, a method of mixing by using a revolution/rotation type stirring machine, and the like. A single- or multi-screw kneading machine is preferably used as the kneading machine (extruder), and a double-screw kneading machine is preferably used.

The mixing temperature is preferably equal to or higher than the processing temperature, that is, the melting temperature, of the resin used. With the mixing temperature set to be equal to or higher than the melting temperature, nanofibers are formed from the cellulose fibers (nano-fibrillation) by the effect of the fibrillation aid, without degrading dispersibility. By adding the dispersant, the surfaces of the fibrillated cellulose nanofibers are coated with the dispersant, and thus dispersibility is further improved (nano-dispersion), thereby producing an ideal CNF-reinforced resin composite material.

The mixing temperature is preferably about 140° C. to 200° C.

The mixing time is preferably about 10 minutes to 1 hour.

The resin composition (resin composite material) of the present invention can be prepared by mixing the cellulose fibers with the resin by preferably using the fibrillation aid and the dispersant, and thus the cellulose fibers (CNF) and the resin are easily mixed in the resin composition.

In a usual resin composition, cellulose fibers (CNF) having high hydrophilicity are hardly mixed with a plastic resin (PP, PE, or the like) having high hydrophobicity. In the resin composition of the present invention, the cellulose fibers (CNF) are sufficiently dispersed in the resin. The molding material or molded product produced by using the resin composition has high strength and high elastic modulus.

The production method of the present invention can simultaneously perform preparation of CNF, dispersion of CNF in the resin, and compounding of CNF with the resin. This can produce the CNF-reinforced resin. The method for producing the CNF-reinforced resin is a process with low environmental load and is thus a process capable of realizing low cost and high practicality.

That is, in the present invention, preparation of CNF and dispersion of CNF in the resin can be simultaneously performed by a single operation, and this is a simultaneous process (SFC process) of nano-fibrillation and nano-dispersion. The present invention can realize a decrease in production cost of the CNF-reinforced resin composite material.

The production process of the present invention is an aqueous pretreatment process without using an organic solvent. This process can efficiently produce CNF from wood-derived pulp by kneading treatment using a double-screw extruder or the like. At the same time, the process can sufficiently disperse the resultant CNF in the resin.

The process uses the fibrillation aid and the dispersant (preferably the water-soluble dispersant) for the pulp, and thus the resin composite material can be produced at low cost. That is, in the present invention, the fibrillation aid and the resin (high-density polyethylene or the like) are added to the wood-derived pulp to prepare the mixture (premix). The pulp is fibrillated to the nano-level by melt-kneading the mixture by using the double-screw extruder or the like.

As a result, the composite material containing CNF and exhibiting high mechanical properties can be produced.

Further, in the present invention, the composite resin material exhibiting higher mechanical properties can be produced by using the wood-derived pulp treated with the dispersant (preferably the polymer dispersant) as a raw material.

The present invention can prepare the composite resin material without using a special dehydrator and thus can provide a process for producing the composite resin material with low cost and a little environmental load.

The resin composition of the present invention contains the fibrillation aid and preferably the dispersant and thus contains the cellulose fibers (preferably CNF) sufficiently dispersed in the resin, thereby exhibiting strength and high mechanical properties.

The present invention preferably provides a composition containing cellulose fibers and a fibrillation aid, for producing a resin composition. The composition preferably further contains a dispersant.

Therefore, the composition of the present invention contains the cellulose fibers (preferably CNF) sufficiently dispersed in a resin by using the fibrillation aid and the dispersant. When the composition of the present invention is used for a resin, a resin composition having strength and exhibiting high mechanical properties can be produced.

(3) Resin Molding Material and Resin Molded Product

A molding material can be produced by using the resin composition of the present invention and compounding the cellulose fibers with the resin. A molded product (molded article) can be produced from the molding material of the present invention.

The molded product of the present invention containing the cellulose fibers and the resin exhibits high tensile strength and elastic modulus because the cellulose fibers are sufficiently dispersed in the resin.

The resin composition can be molded into a desired shape and used as a molding material. Examples of the shape of the molding material include a sheet, a pellet, a powder, the like. The molding material having such a shape can be produced by, for example, using compression molding, injection molding, extrusion molding, hollow molding, foam molding, or the like.

In the present invention, the molded product can be molded by using the molding material. The molding conditions of the resin may be properly adjusted according to demand and used. The molded product of the present invention can be used in the field in which higher mechanical strength (tensile strength or the like) is required, in addition to the fiber-reinforced plastic field using a cellulose fiber (CNF)-containing resin molded product.

The molded product can be effectively used for, for example, interior materials, exterior materials, structural materials, and the like of transport equipment such as an automobile, a train, a ship, an airplane, and the like; housings, structural materials, inner parts, and the like of electric appliances such as a personal computer, a television, a telephone, a watch, and the like; housings, structural materials, inner parts, and the like of mobile communication equipment such as a cellular phone and the like; housings, structural materials, inner parts, and the like of a portable music reproducing equipment, video reproducing equipment, printing equipment, copying equipment, sport goods, and the like; construction materials; office appliances such as a stationary and the like; vessels, containers, and the like.

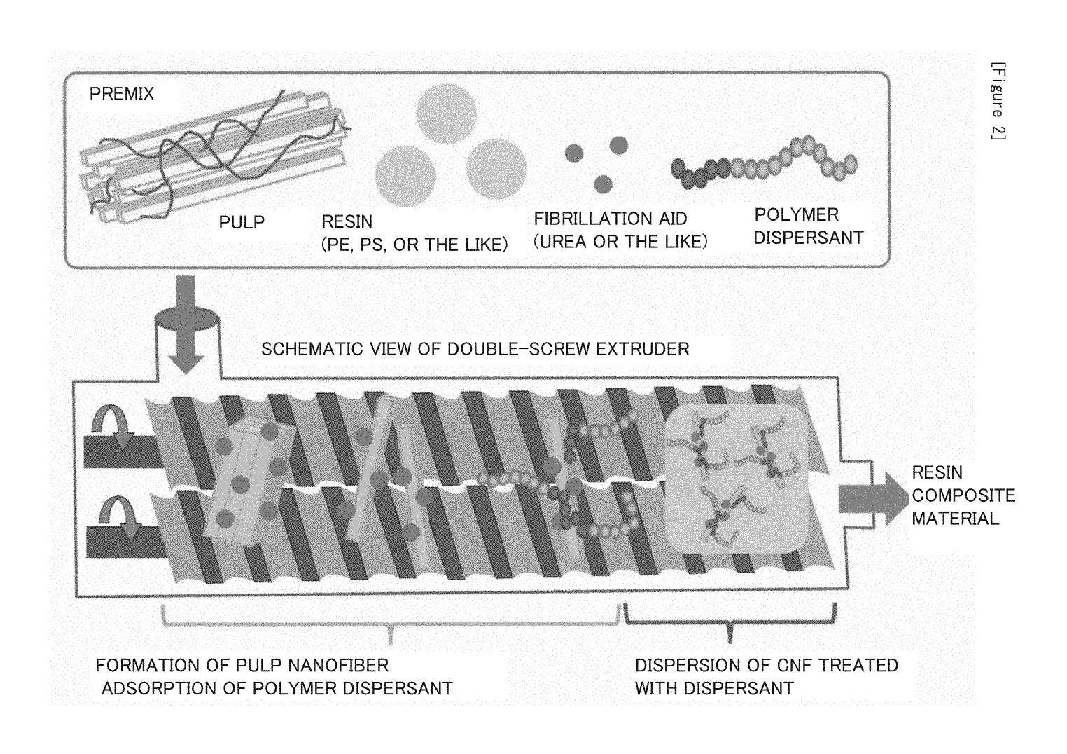

FIG. 2 is a schematic view showing a SFC process which is the method for producing the resin composition of the present invention containing the cellulose fibers (CNF or the like), the fibrillation aid, the dispersant, and the resin. In the resin composition of the present invention, the cellulose fibers (CNF or the like) can be mixed with a hydrophobic resin, and cellulose nanofibers (CNF) can be formed and satisfactorily dispersed by a double-screw extruder.

Since the surfaces of cellulose have hydroxyl groups, cellulose is effectively coated with the affinitive segment B of the dispersant. The cellulose surfaces are hydrophobilized with the resin-affinitive segment A of the dispersant. Thus, the surface-hydrophobilized cellulose is uniformly dispersed even in a thermoplastic resin having very high hydrophobicity, such as polyethylene (PE), polypropylene (PP), or the like.

The resin-affinitive segment A of the dispersant improves the interfacial strength between the cellulose and the resin. By using the composition of the present invention, aggregation of cellulose in the resin can be suppressed, thereby producing the composite material and molded product having excellent strength and elastic modulus.

The dispersant contained in the composition of the present invention contains the resin-affinitive segment A which is preferably composed of a block copolymer or gradient copolymer containing dicyclopentenyloxyethyl methacrylate (DCPOEMA). The cellulose-affinitive segment B preferably contains [2-(methacryloyloxy)ethyl]trimethyl ammonium iodide (DMAEMA-Me⁺I⁻).

When the fibrillation aid and the dispersant are added before the cellulose fibers are mixed with the resin (PE, PP, PS, or the like), aggregation of the cellulose fibers (CNF) does not occur in the resin.

### Example

The present invention is described in further detail below by giving examples and comparative examples.

The present invention is not limited to these examples.

### Examples

Each of the examples relates to a technique for producing a resin composite material at low cost by using a fibrillation aid (urea or the like) and a dispersant (water-soluble dispersant or the like) for pulp. This process is an aqueous pretreatment process without using an organic solvent.

(1) Dispersant used (block copolymer)

The form of the dispersant is shown below.

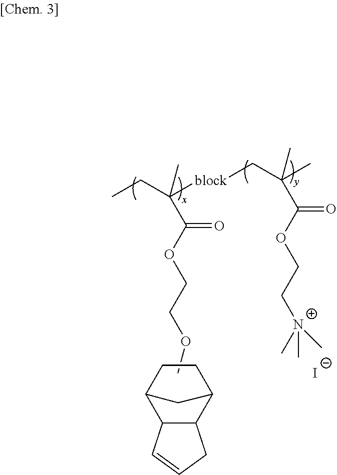

Table 4 shows the forms of dispersants.

TABLE 4
Form of dispersant

| | | Number- | | Number- | | |
|---|---|---|---|---|---|---|
| | | average | Molecular | average | | |
| | | molecular | weight | polymerization | | Polymerization |
| | | weight | distribution | degree | | degree |
| | | calculated | calculated | calculated | | calculated |
| | A-chain | from GPC | from GPC | from GPC | B-chain | from NMR |
| code name | monomer | Mₙ | M_{w}/Mₙ | DPₙ | monomer | DPₙ |
| Dispersant 1 | DCPOEMA | 3,200 | 1.25 | 12 | DMAEMA-Me⁺I⁻ | 31 |
| Dispersant 2 | DCPOEMA | 4,200 | 1.16 | 16 | DMAEMA-Me⁺I⁻ | 32 |
| Dispersant 3 | DCPOEMA | 5,200 | 1.13 | 20 | DMAEMA-Me⁺I⁻ | 33 |

A monomer: dicyclopentenyloxyethyl methacrylate (DCPOEMA) (manufactured by Hitachi Chemical Co., Ltd., FA-512M) used for a resin-affinitive segment (chain A) was dissolved in an amphipathic solvent (for example, propylene glycol monopropyl ether), and subjected to living polymerization in the presence of a catalyst. As a result, a 1^{st} block: poly(dicyclopentenyloxyethyl methacrylate) (polyDCPOEMA) was prepared.

A predetermined time after, a monomer used for a cellulose-affinitive segment (chain B): 2-(dimethylamino)ethyl methacrylate (DMAEMA) was added to synthesize a block copolymer. As a result, a 2^{nd} block; poly-2-(dimethylamino)ethyl methacrylate (polyDMAEMA) was prepared.

The prepared block copolymer was added dropwise to a water/methanol (4:1) mixed solvent to be precipitated as a solid. Then, the catalyst and remaining monomers were removed.

Next, the resultant block copolymer was dissolved in dehydrated acetone, and 1 equivalent of methyl iodide relative to the DMAEMA component was added dropwise to the resultant solution in an argon gas atmosphere in an ice bath. The resultant mixture was stirred overnight at room temperature and then added dropwise to a water/methanol (4:1) mixed solvent to be precipitate as a solid, thereby preparing each of dispersants 1 to 3.

Table 5 shows the solubility of each of the resultant dispersants 1 to 3.

TABLE 5
Solubility of dispersant (polymer concentration: 20 wt %)

| | | IPA:Water | IPA:Water | IPA:Water |
|---|---|---|---|---|
| | Water | (1:3 (w/w)) | (1:2 (w/w)) | (1:1 (w/w)) |
| Dispersant 1 | Insoluble | Insoluble | Soluble | Soluble |
| Dispersant 2 | Insoluble | Insoluble | Soluble | Soluble |
| Dispersant 3 | Insoluble | Insoluble | Soluble | Soluble |

The dispersion 1 was insoluble in water. The dispersant 1 was soluble in a solvent prepared by mixing 2-propanol (isopropanol, IPA) and could be sufficiently dissolved, particularly, in a mixed solvent of IPA and water at a weight ratio of 1:2 or 1:1.

When a water/IPA (1:1 (w/w)) solution (20 wt %) of the dispersant 2 or dispersant 3 was diluted with water until the polymer concentration was 2 wt %, no precipitation occurred.

The resultant dispersants were confirmed to exhibit water solubility without precipitation even when added to a water slurry of pulp.

(2) Preparation of Cellulose Fibers

Each of wood pulps 2 to 4 and 6 to 8 was beaten by using a Niagara beater. Each of the wood pulps was concentrated by suction filtration and centrifugal separation to produce a water-wet slurry.

Table 6 shows the forms of the wood pulps.

TABLE 6
Form of pulp

| | | Beating | Average | Water | | Pulp | Specific | |
|---|---|---|---|---|---|---|---|---|
| | | time | fiber length | retention | Freeness | viscosity | surface area | Crystallinity |
| | | (h) | (mm) | (%) | (mL) | (cP) | (m²/g) | (%) |
| Pulp 1 | NBKP | 0 | 2.84 | 135 | 718 | 11.5 | 13.1 | 81.7 |
| Pulp 2 | NBKP | 2 | 2.84 | 168 | 263 | 16.4 | 24.1 | 79.2 |
| Pulp 3 | NBKP | 4 | 2.81 | 199 | 77 | 14.7 | 32.6 | 75.9 |
| Pulp 4 | NBKP | 6 | 2.62 | 233 | 15 | 14.7 | 34.1 | 70.6 |
| Pulp 5 | LBKP | 0 | 0.74 | 127 | 538 | 7.7 | — | — |
| Pulp 6 | LBKP | 4 | 0.51 | 227 | 16 | 7.9 | — | — |
| Pulp 7 | NUKP | 4 | 2.79 | 186 | 148 | 17.4 | — | — |
| Pulp 8 | BTMP | 2 | 0.69 | 116 | 31 | 2.1 | — | — |

A water suspension (water suspension at a pulp slurry concentration of 3% by weight) was prepared by adding water to the water-wet slurry of each of needle-leaf bleached kraft pulp (NBKP), broadleaf kraft pulp (LBKP), needle-leaf unbleached kraft pulp (NUKP), and bleached thermomechanical pulp (BTMP).

(3) Preparation of Premix

(3-1) Method for Preparing Cellulose Fibers/Resin

A water suspension at 3% by weight of pulp was mixed with high-density polyethylene (Flowbeads HE3040 manufactured by Sumitomo Seika Chemicals Co., Ltd.) at a ratio of 30:40 (w/w) and then dried overnight by using an air dryer (set to 105° C.), thereby producing a cellulose fibers/resin premix (PM-1).

(3-2) Method for Preparing Cellulose Fibers/Resin/Dispersant

A dispersant solution of 20% by weight was prepared by dissolving the dispersant 3 in a mixed solvent of 2-propanol (IPA) and water (1:2, w/w).

A pulp, HDPE, and the dispersant at a predetermined ratio of 30:70-x:x (w/w/w) (x=each of 6, 9. 12, 15, 18, 24, and 30) were mixed and then dried overnight by using an air dryer (set to 105° C.), thereby producing a dried material of cellulose fibers/resin. The dried material was ground to prepare a premix (each of PM-2 to PM-8)).

Table 7 shows the forms of the premixes.

In the table, HDPE presents high-density polyethylene.

TABLE 7
Form of premix

| | Cellulose fiber | | HDPE | Dispersant | |
|---|---|---|---|---|---|
| | | Weight (g) | Weight (g) | | Weight (g) |
| PM1 | Pulp 3 | 30 | 70 | Dispersant 3 | 0 |
| PM2 | Pulp 3 | 30 | 64 | Dispersant 3 | 6 |
| PM3 | Pulp 3 | 30 | 61 | Dispersant 3 | 9 |
| PM4 | Pulp 3 | 30 | 58 | Dispersant 3 | 12 |
| PM5 | Pulp 3 | 30 | 55 | Dispersant 3 | 15 |
| PM6 | Pulp 3 | 30 | 52 | Dispersant 3 | 18 |
| PM7 | Pulp 3 | 30 | 46 | Dispersant 3 | 24 |
| PM8 | Pulp 3 | 30 | 40 | Dispersant 3 | 30 |
| PM9 | Pulp 1 | 30 | 52 | Dispersant 3 | 18 |
| PM10 | Pulp 2 | 30 | 52 | Dispersant 3 | 18 |
| PM11 | Pulp 4 | 30 | 52 | Dispersant 3 | 18 |
| PM12 | Pulp 5 | 30 | 52 | Dispersant 3 | 18 |
| PM13 | Pulp 6 | 30 | 52 | Dispersant 3 | 18 |

(4) Preparation 1 of Resin Composition (PE)

Method for Preparing Cellulose Fibers (CNF)/Fibrillation Aid/Dispersant/Resin

TABLE 8
Preparation of melt-kneading sample

| Sam- | | | Fibril- | Cellulose/ | |
|---|---|---|---|---|---|
| ple | | | lation | dispersant/resin/ | Kneading |
| No. | Premix | Dispersant | aid | fibrillation aid | condition |
| 1 | — | — | — | 0/0/100/0 | Condition 2 |
| 2 | — | — | Urea | 0/0/96/4 | Condition 2 |
| 3 | PM1 | — | — | 10/0/90/0 | Condition 2 |
| 4 | PM1 | — | Urea | 10/0/89/1 | Condition 2 |
| 5 | PM1 | — | Urea | 10/0/88/2 | Condition 2 |
| 6 | PM1 | — | Urea | 10/0/87/3 | Condition 2 |
| 7 | PM1 | — | Urea | 10/0/86/4 | Condition 2 |
| 8 | PM1 | — | Urea | 10/0/85/5 | Condition 2 |
| 9 | — | Dispersant 3 | — | 0/6/94/0 | Condition 2 |
| 10 | — | Dispersant 3 | Urea | 0/6/90/4 | Condition 2 |
| 11 | PM8 | Dispersant 3 | — | 10/10/80/0 | Condition 2 |
| 12 | PM8 | Dispersant 3 | Urea | 10/10/79/1 | Condition 2 |
| 13 | PM8 | Dispersant 3 | Urea | 10/10/78/2 | Condition 2 |
| 14 | PM8 | Dispersant 3 | Urea | 10/10/77/3 | Condition 2 |
| 15 | PM8 | Dispersant 3 | Urea | 10/10/76/4 | Condition 2 |
| 16 | PM8 | Dispersant 3 | Urea | 10/10/75/5 | Condition 2 |
| 17 | PM2 | Dispersant 3 | Urea | 10/2/84/4 | Condition 2 |
| 18 | PM3 | Dispersant 3 | Urea | 10/3/83/4 | Condition 2 |
| 19 | PM4 | Dispersant 3 | Urea | 10/4/82/4 | Condition 2 |
| 20 | PM5 | Dispersant 3 | Urea | 10/5/81/4 | Condition 2 |
| 21 | PM6 | Dispersant 3 | Urea | 10/6/80/4 | Condition 2 |
| 22 | PM7 | Dispersant 3 | Urea | 10/8/78/4 | Condition 2 |
| 23 | PM8 | Dispersant 3 | Urea | 10/10/76/4 | Condition 2 |
| 24 | PM6 | Dispersant 3 | Urea | 10/6/80/4 | Condition 1 |
| 25 | PM6 | Dispersant 3 | Urea | 10/6/80/4 | Condition 3 |
| 26 | PM6 | Dispersant 3 | Urea | 10/6/80/4 | Condition 4 |
| 27 | PM6 | Dispersant 3 | Urea | 10/6/80/4 | Condition 5 |
| 28 | PM6 | Dispersant 3 | Urea | 10/6/80/4 | Condition 6 |
| 29 | PM6 | Dispersant 3 | Biuret | 10/6/80/4 | Condition 2 |
| 30 | PM9 | Dispersant 3 | Urea | 10/6/80/4 | Condition 2 |
| 31 | PM10 | Dispersant 3 | Urea | 10/6/80/4 | Condition 2 |
| 32 | PM11 | Dispersant 3 | Urea | 10/6/80/4 | Condition 2 |
| 33 | PM12 | Dispersant 3 | Urea | 10/6/80/4 | Condition 2 |
| 34 | PM13 | Dispersant 3 | Urea | 10/6/80/4 | Condition 2 |
| 35 | PM1 | — | — | 10/0/90/0 | Condition 7 |
| 36 | PM1 | — | Urea | 10/0/86/4 | Condition 7 |
| 37 | PM8 | Dispersant 3 | Urea | 10/10/76/4 | Condition 7 |
| 38 | PM6 | Dispersant 3 | D- | 10/6/80/4 | Condition 2 |
| | | | glucose | | |

TABLE 9
Kneading condition

| | Rotational | Temperature | Time |
|---|---|---|---|
| | speed (rpm) | (° C.) | (min) |
| Condition 1 | 200 | 140 | 30 |
| Condition 2 | 200 | 140 | 60 |
| Condition 3 | 200 | 140 | 90 |
| Condition 4 | 200 | 140 | 120 |
| Condition 5 | 200 | 140 | 150 |
| Condition 6 | 200 | 140 | 180 |
| Condition 7 | 100 | 140 | 60 |

A melt-kneading sample was prepared by mixing a premix, a fibrillation aid, and a dilution resin according to each of the mixing compositions shown in Table 8. Each of the samples was supplied to a double-screw kneader and melt-kneaded under the conditions shown in Table 9.

Each of urea and biuret was used as the fibrillation aid.

A high-density polyethylene (HDPE, J320, manufactured by Asahi Kasei Corporation) was used as the dilution resin.

Kneading Conditions
Kneading apparatus: Xplore MC15K manufactured by Xplore Instruments
Kneading conditions: refer to Table 9

Injection Molding Conditions
Injection molding machine: IM12K manufactured by Xplore Instruments
Molding condition: molding temperature=150° C. (for PE)
Mold temperature: 50° C.
Injection pressure: 10 bar/5 s→13 bar/32 s

Tensile Test

An elastic modulus and tensile strength were measured by using an electromechanical universal testing machine (manufactured by Instron Corp.) at a test speed of 1.5 mm/min (load cell: 5 kN). In this test, a fulcrum distance was 4.5 cm.

Evaluation of Fibrillation Properties

A thin piece of 20 μm was cut out from a dumbbell molded product by using a microtome, heated to 140° C. (for HDPE) by a hot stage, and observed by a polarization microscope.

(5) Optimization of Amount of Urea Added During Kneading

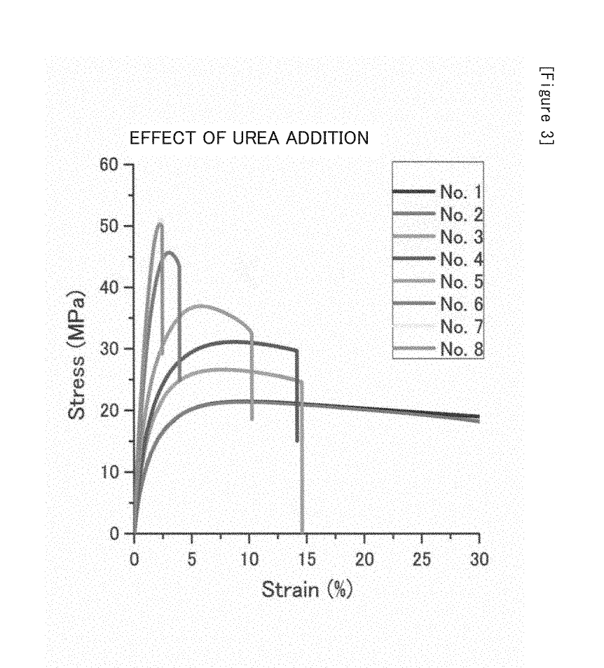

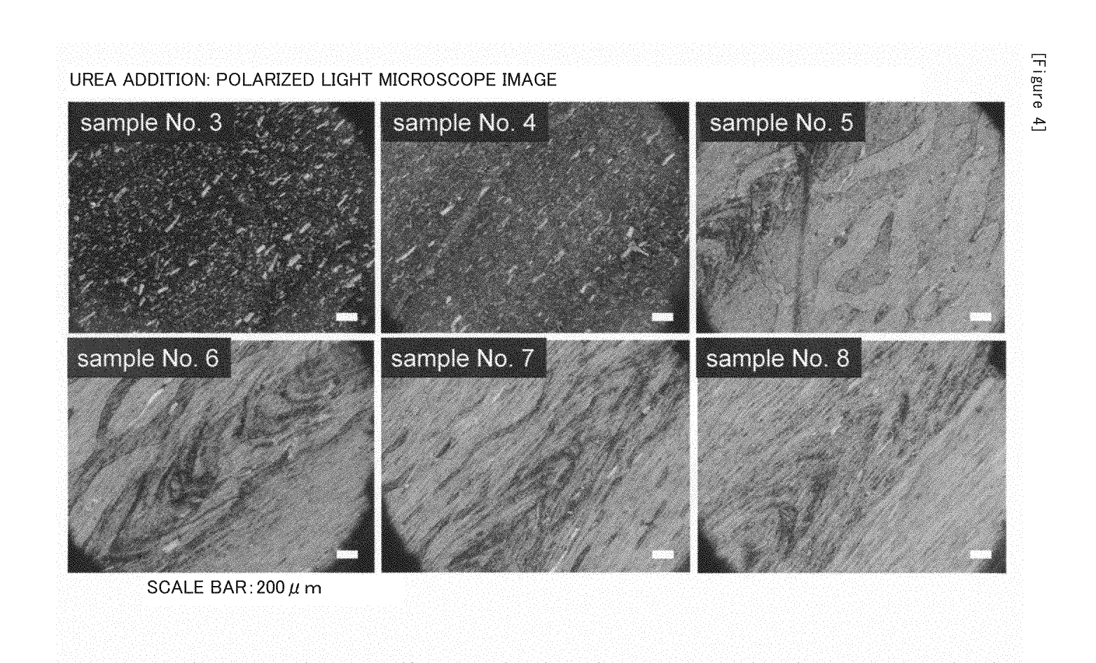

The results of evaluation are shown in FIG. 3 and Table 10. FIG. 3 shows tension-strain curves (SS curves) indicating the urea addition effect. FIG. 4 shows the results of polarized light microscopy of CNF/PE composites each using urea as the fibrillation aid.

The dispersant was not added.

TABLE 10
Evaluation results of urea addition

| | Tensile modulus | Strength | Breaking elongation |
|---|---|---|---|
| Sample No. | (GPa) | (MPa) | (%) |
| 1 | 0.75 | 21.4 | — |
| 2 | 0.77 | 21.4 | — |
| 3 | 1.20 | 25.7 | 13.5 |
| 4 | 1.19 | 31.0 | 15.2 |
| 5 | 1.84 | 37.0 | 10.0 |
| 6 | 3.11 | 45.5 | 4.1 |
| 7 | 3.76 | 51.0 | 2.5 |
| 8 | 3.97 | 49.9 | 2.4 |

The elastic modulus and strength were significantly improved by adding urea as the fibrillation aid.

Also, an increase in amount of the fibrillation aid added decreased the number of thick fibers derived from the pulp and increased the scattered light due to CNF, and thus proceeding of CNF formation was confirmed.

(6) Preparation 2 of Resin Composition (PE) and

(7) Optimization of Amount of Urea Added in the Case Containing the Dispersant

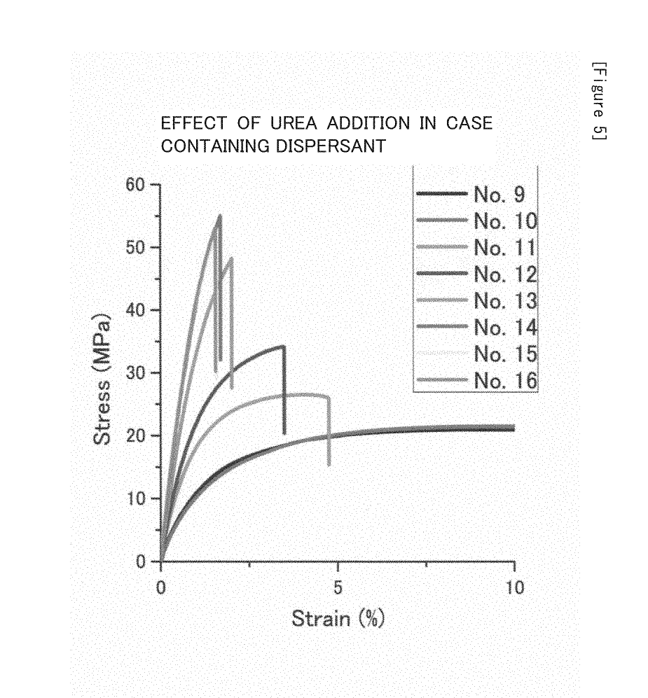

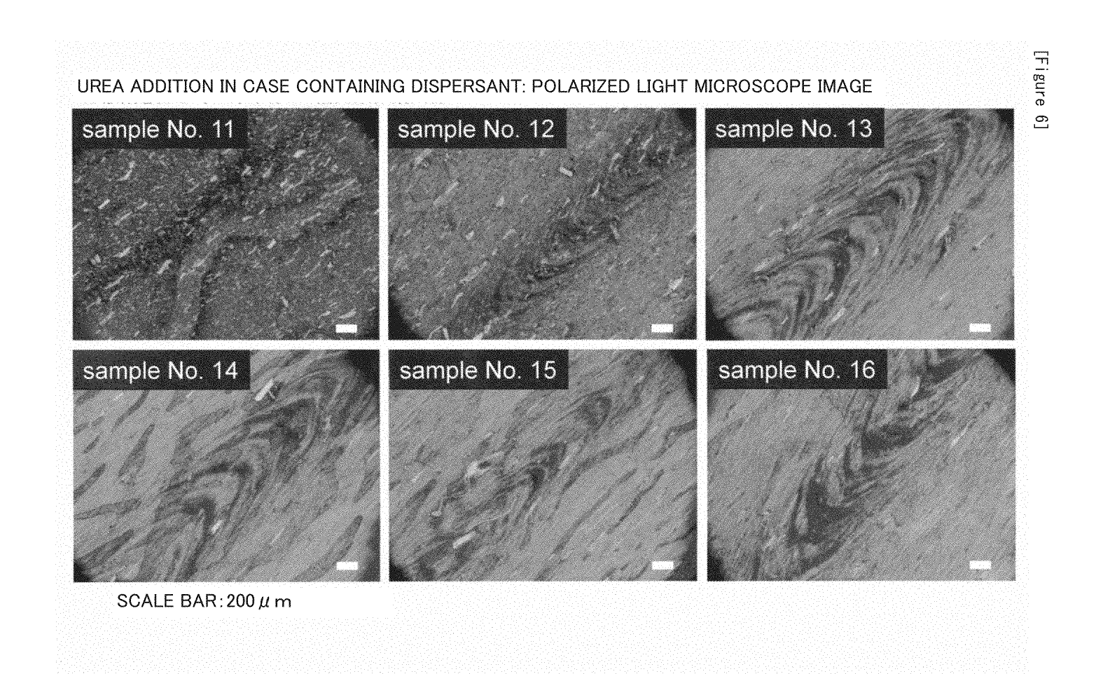

FIG. 5 and Table 11 shows the evaluation results. FIG. 5 shows tension-strain curves (SS curves) of CNF/PE composites each containing both the dispersant and urea. FIG. 6 shows the results of polarized light microscopy of CNF/PE composites each containing both the dispersant and urea.

The dispersant was added.

TABLE 11
Evaluation results of dispersant addition

| | Tensile modulus | Strength | Breaking elongation |
|---|---|---|---|
| Sample No. | (GPa) | (MPa) | (%) |
| 9 | 0.84 | 21.1 | >10 |
| 10 | 0.76 | 21.6 | >10 |
| 11 | 1.96 | 26.4 | 4.7 |
| 12 | 2.46 | 33.9 | 3.6 |
| 13 | 3.94 | 47.4 | 2.0 |
| 14 | 4.80 | 54.5 | 1.7 |
| 15 | 5.03 | 52.9 | 1.6 |
| 16 | 5.17 | 53.3 | 1.6 |

The elastic modulus and strength were confirmed to be further improved by adding the dispersant.

(8) Optimization of Amount of Dispersant Added During Kneading in the Case of Adding the Dispersant

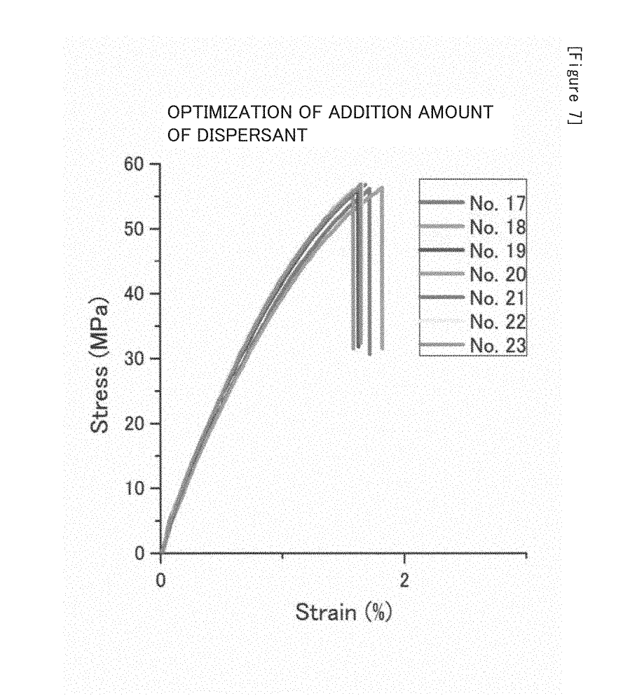

FIG. 7 and Table 12 show the evaluation results. FIG. 7 shows a relation between the amount of dispersant added in a CNF/PE composite and mechanical properties.

TABLE 12
Evaluation results of dispersant addition during kneading

| | Tensile modulus | Strength | Breaking elongation |
|---|---|---|---|
| Sample No. | (GPa) | (MPa) | (%) |
| 17 | 4.71 | 54.7 | 1.7 |
| 18 | 4.67 | 54.9 | 1.8 |
| 19 | 5.01 | 56.1 | 1.7 |
| 20 | 5.01 | 56.6 | 1.7 |
| 21 | 5.03 | 56.2 | 1.7 |
| 22 | 5.00 | 55.9 | 1.7 |
| 23 | 5.15 | 55.9 | 1.7 |

Even when the amount of dispersant added was 2 wt % relative to cellulose, the effect was exhibited.

(9) Optimization of Kneading Time During Kneading in the Case of Adding the Dispersant

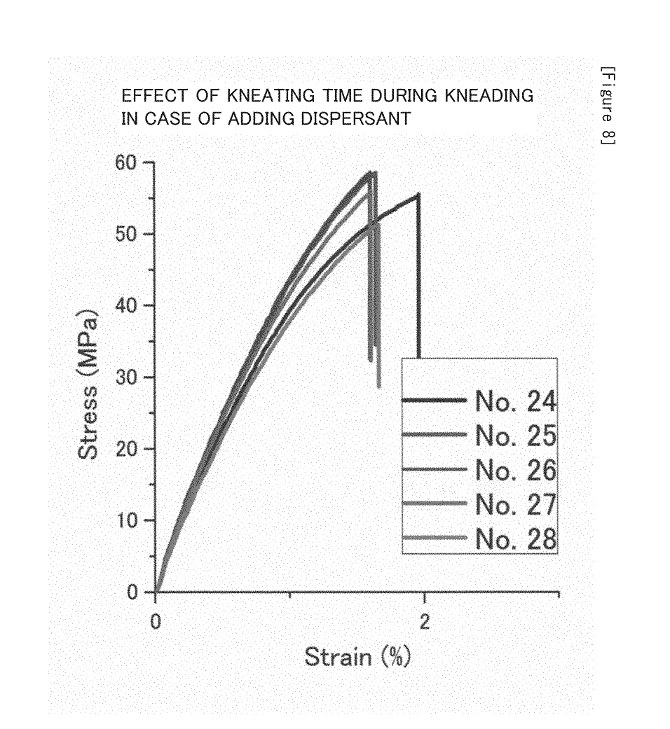

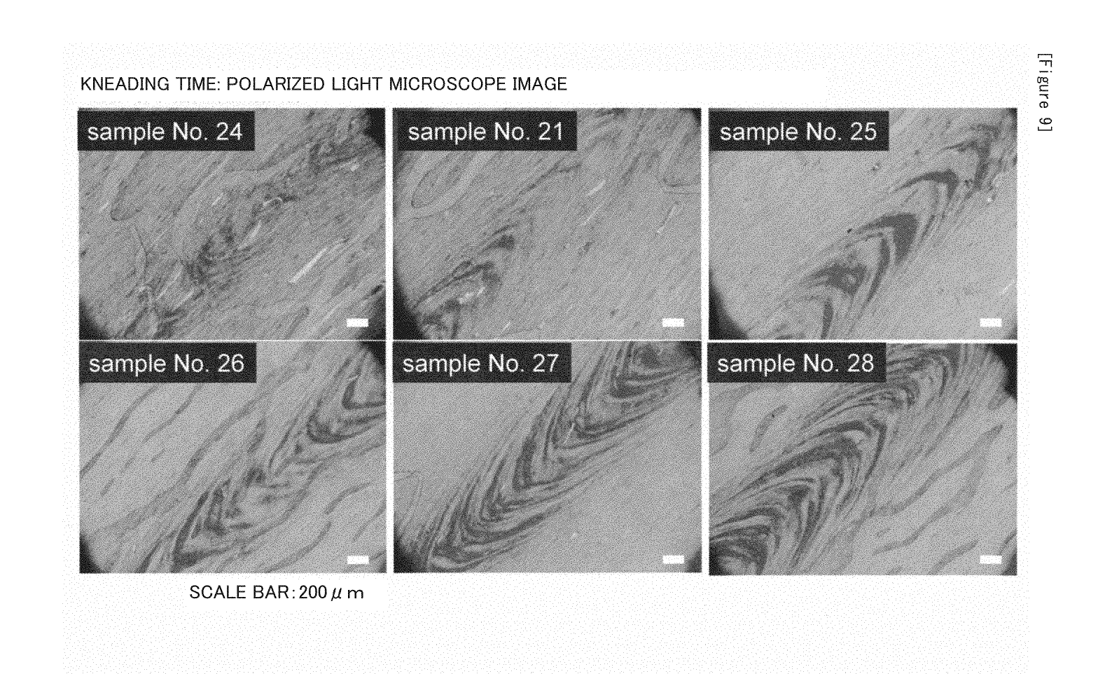

The results of evaluation are shown in FIG. 8 and Table 13. FIG. 8 shows tension-strain curves (SS curves) of CNF-PE composites produced with different kneading times. FIG. 9 shows the results of polarized light microscopy of CNF/PE composites produced with different kneading times.

TABLE 13

| | Tensile modulus | Strength | Breaking elongation |
|---|---|---|---|
| Sample No. | (GPa) | (MPa) | (%) |
| 24 | 4.64 | 54.7 | 2.0 |
| 25 | 5.21 | 57.5 | 1.6 |
| 26 | 5.49 | 56.6 | 1.5 |
| 27 | 5.03 | 54.8 | 1.6 |
| 28 | 4.50 | 50.5 | 1.7 |
| 29 | 4.52 | 50.9 | 1.4 |

The sufficient kneading time was 60 minutes.

The kneading time of 150 minutes or more has the tendency to decrease physical properties (Sample Nos. 27 and 28).

It was confirmed from FIG. 9 that the amount of not-fibrillated fibers is decreased by increasing the kneading time.

The CNF formation and nano-dispersion can be achieved even by using biuret as the fibrillation aid (Sample No. 29).

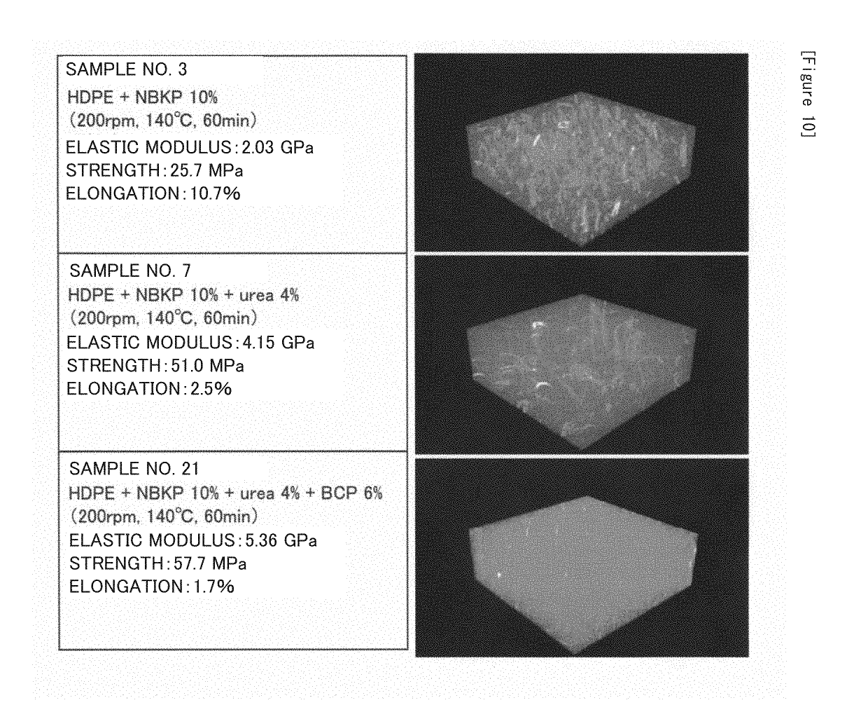

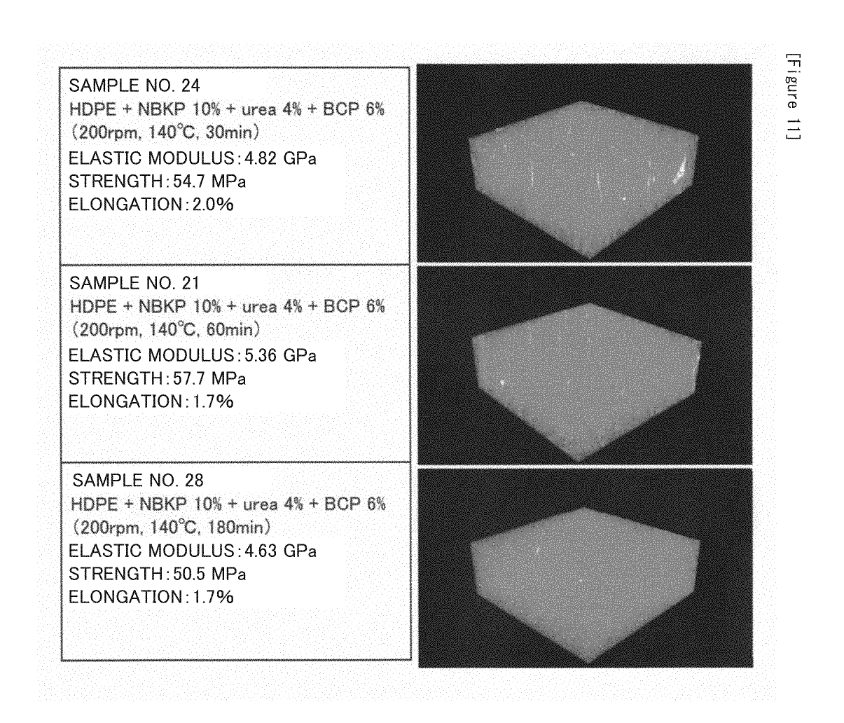

FIGS. 10 and 11 show X-ray CT indicating the fibrillation properties of composites.

FIG. 10 shows comparison between a composite containing neither urea nor the dispersant (Sample No. 3), a composite containing urea without containing the dispersant (Sample No. 7), and a composite containing urea and the dispersant (Sample No. 21).

FIG. 11 shows comparison between the kneading times of 30 minutes (Sample No. 24), 60 minutes (Sample No. 21), and 180 minutes (Sample No. 28) in the presence of urea and the dispersant.

(10) Evaluation with Different Types of Pulp

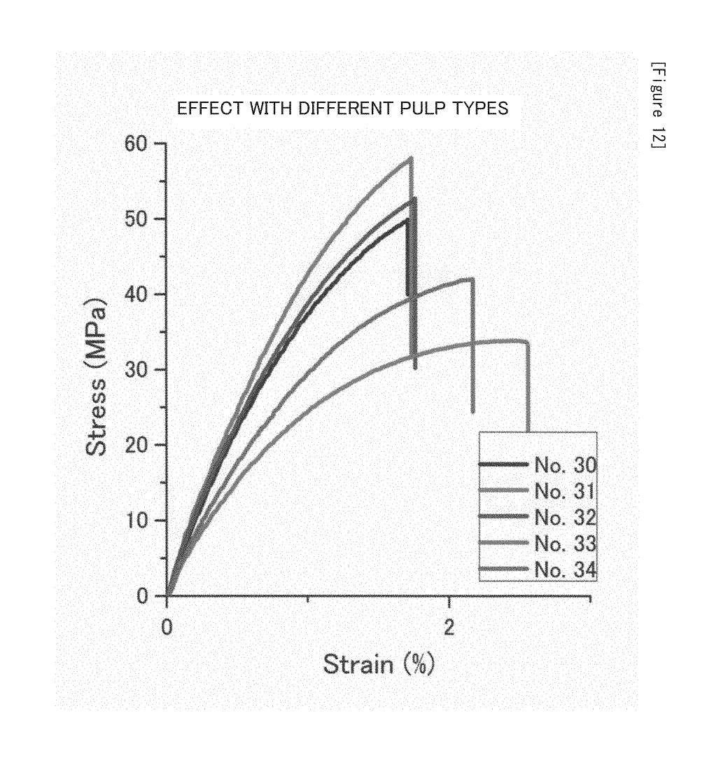

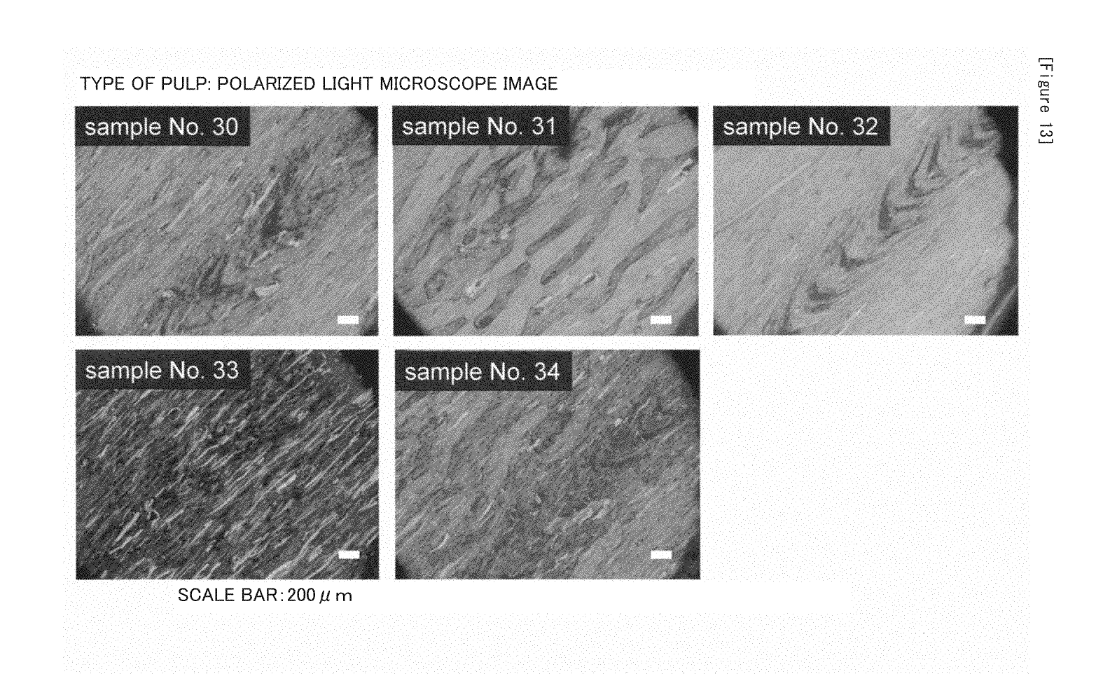

FIG. 12 and Table 14 show the evaluation results. FIG. 12 shows tension-strain curves (SS curves) of composites produced by using different types of pulps. FIG. 13 shows the results of polarized light microscopy of composites produced using different types of pulps.

FIG. 13 shows the results of polarized light microscopy using different types of pulps.

TABLE 14
Evaluation results of kneading time during kneading

| | Tensile modulus | Strength | Breaking elongation |
|---|---|---|---|
| Sample No. | (GPa) | (MPa) | (%) |
| 30 | 4.55 | 48.9 | 1.8 |
| 31 | 5.08 | 56.6 | 1.7 |
| 32 | 4.85 | 54.6 | 1.8 |
| 33 | 3.02 | 34.0 | 2.7 |
| 34 | 3.57 | 41.6 | 1.2 |

In any one of the cases, the mechanical properties are more improved than in the case using only the resin, and acceleration of CNF formation is confirmed by polarized light microscopy of a resin under melting.

As a result of further detailed observation, when NBKP is used as a raw material, beating makes it easy to form nanofibers by a double-screw extruder, resulting in increase in elastic modulus and breaking strength which are indexes for mechanical properties.

On the other hand, when the beating time is excessively increased under the same kneading conditions, the tensile elastic modulus is slightly decreased. However, nanofiber formation easily proceeds.

(11) SEM Observation of Dumbbell Test Piece after Hot-Xylene Treatment

The HDPE resin can be dissolved by dipping a dumbbell test piece in a xylene solvent heated to 160° C.

Therefore, the component remaining after hot-xylene treatment, that is, a cellulose fiber portion of the dumbbell test piece, was taken out and subjected to SEM observation.

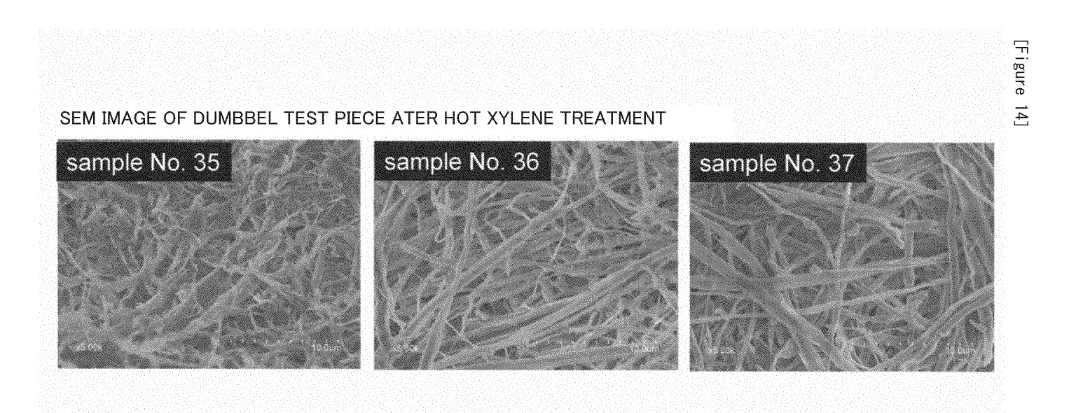

FIG. 14 shows the results of SEM observation of the cellulose fiber portion remaining after hot-xylene treatment of each of the composites.

As shown in FIG. 14, fiber cutting is observed in Sample No. 35 (cellulose/dispersant 3/resin/urea=10/0/80/0) formed by kneading under the conditions 7.

Fiber cutting is significantly suppressed in Sample No. 36 (cellulose/dispersant 3/resin/urea=10/0/86/4) and Sample No. 37 (cellulose/dispersant 3/resin/urea=10/10/76/4). A significant difference is not observed between the SEM images of Sample No. 36 and Sample No. 37, and thus cutting of the cellulose fibers is considered to be suppressed by urea used as the fibrillation aid.

(12) Investigation 1 of Fibrillation Aid

The results obtained by using D-glucose (mp: 146° C. to 150° C.) as the fibrillation aid are shown as an example in a table (Sample No. 38).

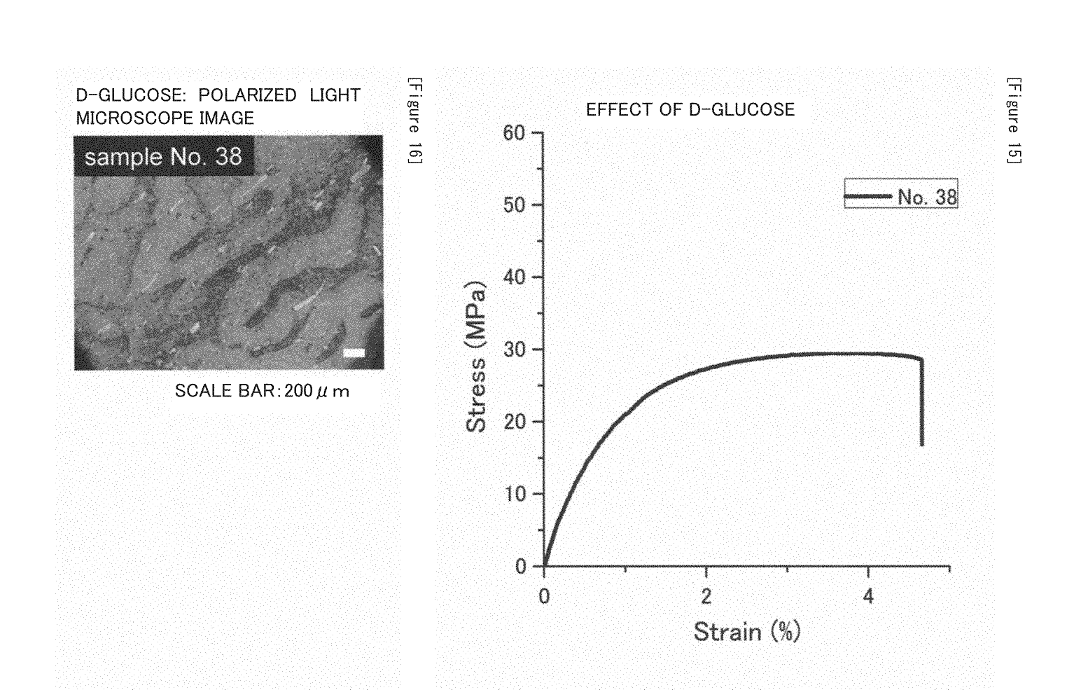

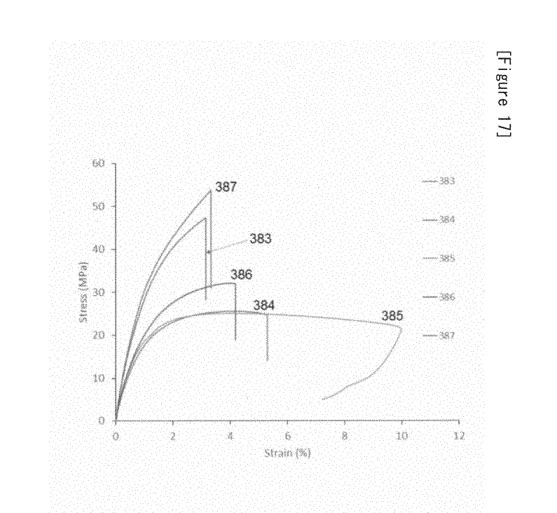

FIG. 15 and Table 15 show the evaluation results. FIG. 15 shows a tension-strain curve (SS curve) of a composite produced by using D-glucose as the fibrillation aid. FIG. 16 shows the results of polarized light microscopy of a composite produced by using D-glucose as the fibrillation aid.

TABLE 15
Evaluation results of D-glucose (fibrillation aid)

| | Tensile modulus | Strength | Breaking elongation |
|---|---|---|---|
| Sample No. | (GPa) | (MPa) | (%) |
| 38 | 2.39 | 29.4 | 4.7 |

Tensile elastic modulus and breaking strength which are indexes for mechanical properties are improved by using, as the fibrillation aid, D-glucose as compared with Sample No. 3 (cellulose/resin=10/90) and Sample No. 11 (cellulose/dispersant 3/resin=10/10/80.

When the fibrillation aid and D-glucose are used, the physical properties are degraded and the fibrillation properties are unsatisfactory as compared with a sample using urea as the fibrillation aid (Sample No. 21) and a sample using biuret (Sample No. 29) under the same conditions.

Therefore, a material having an amino group or a urea bond is preferred as the fibrillation aid.

(13) Investigation 2 of Fibrillation Aid

Shown are the results obtained by using, in place of urea (mp: 133° C. to 135° C.) as the fibrillation aid, D-(+)-glucose (mp: 146° C. to 150° C.), D-glucitol (D-sorbitol (mp: 95° C.), biurea (mp: 247° C. to 250° C.), 2,5-dithiobiurea (mp: 212° C.), 1,3-diphenylurea (mp: 239° C. to 241° C.), or dimethylurea (mp: 101° C. to 104° C.)

A method for preparing a premix (PM) is described.

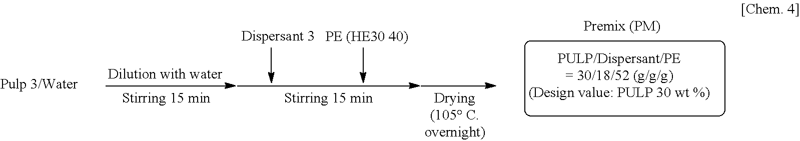

Then, 4% by weight of the fibrillation aid relative to the pulp was added to the resultant premix, and the resultant mixture was diluted with PE so that the pulp concentration was 10% by weight. The resultant mixture was subjected to melt kneading.

Kneading Conditions
Kneading apparatus: Xplore MC15K manufactured by Xplore Instruments
Kneading conditions: double-screw rotational speed: 200 rpm, kneading time: 60 min, kneading temperature: 140° C.

Injection Molding Conditions
Injection molding machine: IM12K manufactured by Xplore Instruments
Molding condition: molding temperature=150° C.
Mold temperature: 50° C.
Injection pressure: 10 bar/5 s→13 bar/32 s

Table 16 shows the details and evaluation results of the fibrillation aids.

TABLE 16

| | | Melting | Molded product | Elastic | | |
|---|---|---|---|---|---|---|
| | Type of | point | PULP/dispersant/ | modulus | Strength | Elongation |
| entry | fibrillation aid | (° C.) | PE/fibrillation aid | (GPa) | (MPa) | (%) |
| 383 | D-glucitol | 95 | 10/6/80/4 | 3.21 | 47.0 | 3.2 |
| 384 | Biurea | 247-250 | 10/6/80/4 | 1.91 | 25.6 | 5.1 |
| 385 | 2,5-Dithiobiurea | 212 | 10/6/80/4 | 2.03 | 25.1 | 10.7 |
| 386 | 1,3-Diphenylurea | 239-241 | 10/6/80/4 | 2.19 | 32.0 | 4.2 |
| 387 | Dimethylurea | 101-104 | 10/6/80/4 | 3.36 | 53.3 | 3.4 |

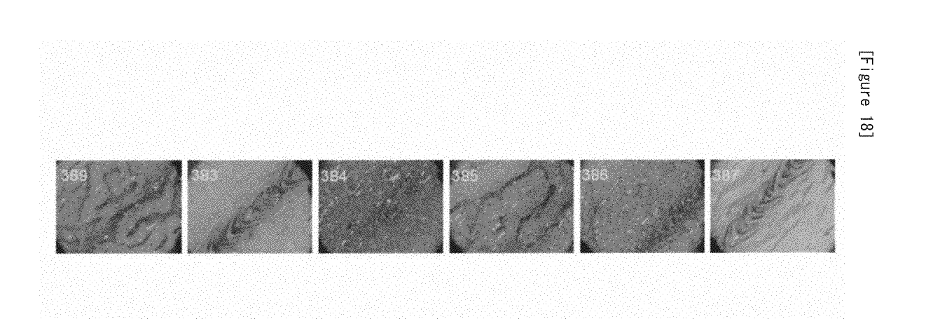

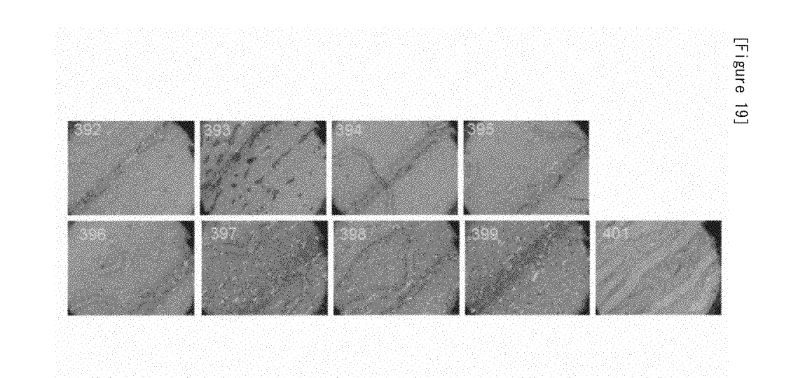

FIG. 17 shows tension-strain curves (SS curves) of composites containing premix PM6/dispersant 3/HDPE/various fibrillation aids. FIG. 18 shows the results of polarized light microscopy of composites containing premix

### PM6/Dispersant 3/HDPE/Various Fibrillation Aids.

Tensile elastic modulus and breaking strength which are indexes for mechanical properties are improved by using dimethylurea, glucitol, or the like as the fibrillation aid.

(14) Investigation 3 of Fibrillation Aid

Shown are the results obtained by using, in place of urea (mp: 133 to 135° C.) as the fibrillation aid, L-(+)-arabinose (mp: 160° C. to 163° C.), D-(+)-xylose (mp: 144° C. to 145° C.), D-(−)-fructose (fruit saccharide) (mp: 104° C.), D-(+)-mannose (mp: 132° C. to 133° C.), L-(+)-ramnose monohydrate (mp: 91° C. to 93° C.), sucrose (mp: 186° C.), maltose monohydrate (malt saccharide) (mp: 160° C. to 165° C.), D-(+)-trehalose dihydrate (mp: 203° C.), or xylitol (mp: 92° C. to 96° C.)

Kneading conditions: 200 rpm, 60 min, 140° C.

A premix was prepared by the same method as in the investigation 2 of the fibrillation aid. Then, 4% by weight of the fibrillation aid relative to the pulp was added to the resultant premix, and the resultant mixture was diluted with PE so that the pulp concentration was 10% by weight. The product was subjected to melt kneading.

Table 17 shows the details and evaluation results of the fibrillation aids.

TABLE 17

| | | Melting | Molded product | Elastic | | |
|---|---|---|---|---|---|---|
| | Type of | point | PULP/dispersant/ | modulus | Strength | Elongation |
| entry | fibrillation aid | (° C.) | PE/fibrillation aid | (GPa) | (MPa) | (%) |
| 392 | L-(+)-arabinose | 160-163 | 10/6/80/4 | 2.31 | 28.5 | 5.1 |
| 393 | D-(+)-Xylose | 144-145 | 10/6/80/4 | 2.31 | 28.2 | 5.3 |
| 394 | D-(−)-Fructose (fruit sugar) | 104 | 10/6/80/4 | 2.25 | 28.5 | 4.7 |
| | | | | 2.81 | | |
| 395 | D-(+)-Mannose | 132-133 | 10/6/80/4 | 2.23 | 28.8 | 4.6 |
| 396 | L-(+)-Ramnose | 91-93 | 10/6/80/4 | 2.29 | 30.6 | 4.2 |
| | monohydrate | | | | | |
| 397 | Sucrose | 186 | 10/6/80/4 | 2.13 | 26.9 | 5.5 |
| 398 | Maltose monohydrate | 160-165 | 10/6/80/4 | 2.07 | 26.8 | 5.6 |
| | (malt sugar) | | | | | |
| 399 | D-(+)-Trehalose dihydrate | 203 | 10/6/80/4 | 2.04 | 27.7 | 4.4 |
| 401 | Xylitol | 92-96 | 10/6/80/4 | 2.49 | 43.6 | 4.1 |

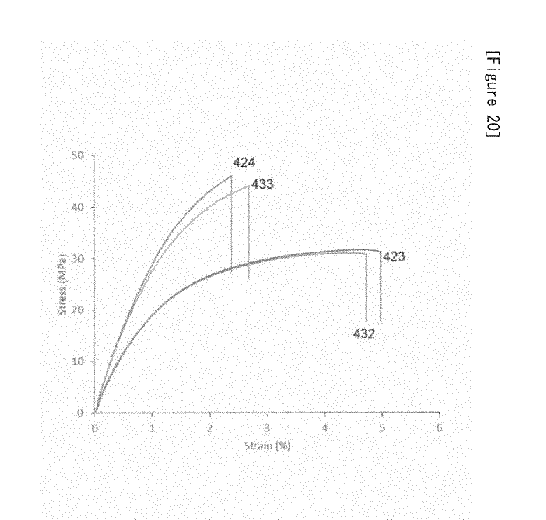

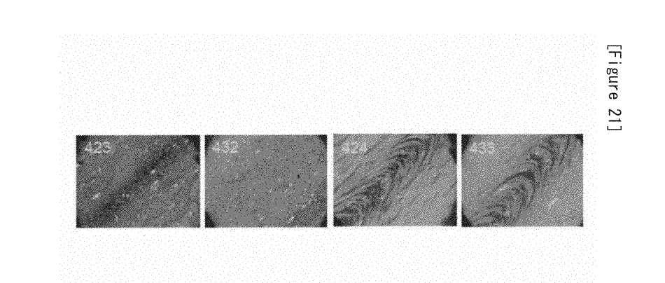

FIG. 19 shows the results of polarized light microscopy of composites containing premix PM6/dispersant 3/HDPE/various fibrillation aids.

Tensile elastic modulus and breaking strength which are indexes for mechanical properties are improved by adding xylitol as the fibrillation aid.

(15) Investigation 1 of Addition Timing of Fibrillation Aid

The addition timing in pretreatment was investigated by using urea (mp: 133° C. to 135° C.) as the fibrillation aid.

A method for preparing a premix is described.

Treatment 1 represents stirring for 15 minutes at room temperature, and treatment 2 represents stirring for 60 minutes under a boiling condition.

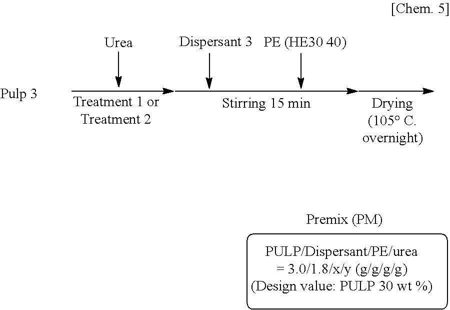

Table 18 shows the details and evaluation results of premixes.

TABLE 18

| | | Final | Molded | | | |
|---|---|---|---|---|---|---|
| | | urea | product | | | |
| | | concen- | PULP/ | Elastic | | Elon- |
| | Treatment | tration | dispersant/ | modulus | Strength | gation |
| entry | method | (%) | PE/urea | (GPa) | (MPa) | (%) |
| 423 | Treatment 1 | 1 | 10/6/83/1 | 1.98 | 31.6 | 4.9 |
| 424 | Treatment 1 | 2 | 10/6/82/2 | 3.21 | 45.6 | 2.4 |
| 432 | Treatment 2 | 1 | 10/6/83/1 | 2.02 | 31.0 | 4.7 |
| 433 | Treatment 2 | 2 | 10/6/82/2 | 2.12 | 43.5 | 2.7 |

Each of the resultant premixes was diluted with PE so that the pulp concentration was 10% by weight. The resultant mixture was subjected to melt kneading.

Kneading Conditions
Kneading apparatus: Xplore MC15K manufactured by Xplore Instruments
Kneading conditions: double-screw rotational speed: 200 rpm, kneading time: 60 min, kneading temperature: 140° C.

Injection Molding Conditions
Injection molding machine: IM12K manufactured by Xplore Instruments
Molding condition: molding temperature=150° C.
Mold temperature: 50° C.
Injection pressure: 10 bar/5 s→13 bar/32 s

Table 20 shows tension-strain curves (SS curves) of composites containing premix PM6/dispersant 3/HDPE/various fibrillation aids. FIG. 21 shows the results of polarized light microscopy of composites containing premix PM6/dispersant 3/HDPE/various fibrillation aids.

(16) Investigation 4 of Fibrillation Aid

NBKP beaten by using a Niagara beater so that the freeness was 150 mL or less was used and kneaded by a SFC process for 60 minutes at 140° C. and 200 rpm, thereby producing CNF composite PE.

Sodium citrate, ammonium citrate, ammonium acetate, or glycerin was used as the fibrillation aid, and the pulp/dispersant/PE/fibrillation aid was 10/0/86/4% by mass.

The fibrillation aid was added immediately before kneading by the SFC process.

Results and Consideration (Table 19)

Any one of the CNF composite PE produced by adding four types of fibrillation aids showed higher tensile strength and elastic modulus than the case where the fibrillation aid was not added. In particular, the system in which glycerin was added showed the highest physical properties.

The physical properties of the CNF composite PE were improved by adding the fibrillation aid, and the CNF composite PE using glycerin showed the highest physical properties. However, pulp fibrillation could be confirmed by polarized light microscopy of the CNF composite PE. It is thus considered that acceleration of pulp fibrillation by the fibrillation aid in the SFC process contributes to improvement in the physical properties.

Pulp fibrillation is accelerated by adding as the fibrillation aid sodium citrate, ammonium citrate, ammonium acetate, or glycerin, thereby improving the physical properties of the CNF composite PE.

TABLE 19

| | Tensile strength | Tensile modulus |
|---|---|---|
| Fibrillation aid | MPa | GPa |
| Sodium citrate | 27 | 2.2 |
| Ammonium citrate | 27 | 2.3 |
| Ammonium acetate | 28 | 2.2 |
| Glycerin | 36 | 2.5 |
| No fibrillation aid | 26 | 2.0 |

(17) Investigation of Amount of Fibrillation Aid Added

An investigation was made about the optimum amount of glycerin added which had the highest effect among the fibrillation aids investigated as described above.

NBKP beaten by using a Niagara beater so that the freeness was 150 mL or less was used and kneaded for 60 minutes at 140° C. and 200 rpm by a SFC process, thereby producing CNF composite PE.

A pulp/dispersant/PE/fibrillation aid at 10/0/86/4% by mass was used as a base, and a system containing each of 1% by mass and 10% by mass of the fibrillation aid (substituted for PE) was investigated.

The fibrillation aid was previously mixed with the beaten pulp, not immediately before the SFC process.

Result and Consideration (Table 20)

The tensile strength and elastic modulus of the CNF composite PE were improved with increases in the amount of glycerin added as the fibrillation aid.

With the adding amount up to 10% by mass, pulp fibrillation in polarized light microscopy is accelerated by increasing the amount of the fibrillation aid glycerin added, and the physical properties of the CNF composite PE are improved. This is considered to contribute to the more preferred results of improved physical properties.

TABLE 20

| | Tensile strength | Tensile modulus |
|---|---|---|
| | MPa | GPa |
| Glycerin 1 Mass % | 28 | 2.2 |
| Glycerin 4 Mass % | 30 | 2.5 |
| Glycerin 10 Mass % | 32 | 3.0 |

(18) Investigation 2 of Addition Timing of Fibrillation Aid

Comparative evaluation of the physical properties of CNF composite PE and the addition timing was made by using different addition timings of glycerin as the fibrillation aid.

Specifically, in the above description, the pulp was mixed with PE and dried at 105° C. to produce a premix, and then the fibrillation aid was added to the premix, followed by kneading by the SFC process.

However, in this evaluation, the pulp was previously mixed with the fibrillation aid, then mixed with PE, and then dried at 105° C. to form a premix, which was directly kneaded by the SFC process.

Results and Consideration (Table 21)

The physical properties of the CNF composite PE are not significantly changed even by changing the addition timing of the fibrillation aid glycerin.

It is thus found that the physical properties of the CNF composite PE are not changed with the addition timing of the fibrillation aid, and even when the fibrillation aid is added with any desired timing, pulp fibrillation is accelerated, and the physical properties of the CNF composite PE are improved.

TABLE 21

| | Tensile strength | Tensile modulus |
|---|---|---|
| Timing of glycerin addition | MPa | GPa |
| After preparation of premix | 36 | 2.5 |
| (immediately before kneading) | | |
| During preparation of premix | 30 | 2.5 |
| (previous mixing) | | |

(19) Effect of Addition of Commercial Malic Acid PP as Substitute for Polymer Dispersant

A composite material without using a block copolymer-type polymer dispersant in the aqueous SFC process was formed and investigated. Improvements in elastic modulus and strength were confirmed. The SFC process can be expected to be applicable even with optimum MAPP and commercial dispersant.

Table 22 shows the maleic acid PP (MAPP) used.

TABLE 22

| | | Tm (° C.) | |
|---|---|---|---|
| | MFR (g/10 min) | DSC Peak | Molecular |
| Sample name | 190&-2.16 kg | temperature | weight |
| PMA-H1100P | 230 | 150 | Medium |
| (Toyotac manufactured by | | | |
| Toyobo Co., Ltd.) | | | |

A method for preparing the premix (PM). The numerals indicate weights (g).

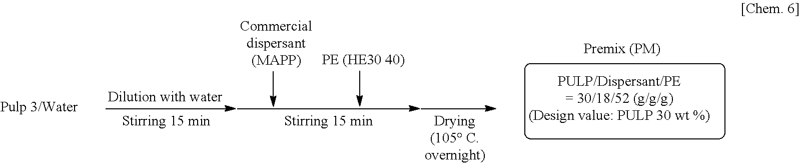

Then, 4% by weight of urea (fibrillation aid) relative to the pulp was added to the resultant premix, and the resultant mixture was diluted with PE so that the pulp concentration was 10% by weight. The product was subjected to melt kneading.

Kneading Conditions
Kneading apparatus: Xplore MC15K manufactured by Xplore Instruments
Kneading conditions: double-screw rotational speed: 200 rpm, kneading time: 60 min, kneading temperature: 140° C.

Injection Molding Conditions
Injection molding machine: IM12K manufactured by Xplore Instruments
Molding condition: molding temperature=150° C.
Mold temperature: 50° C.
Injection pressure: 10 bar/5 s→13 bar/32 s

Table 23 shows the mixing ratio and tensile test results of a sample.

TABLE 23

| | | Molded product | Elastic | | |
|---|---|---|---|---|---|
| | Type of | PULP/MAPP/ | modulus | Strength | Elongation |
| No. | MAPP | PE/urea | (GPa) | (MPa) | (%) |
| 498 | PMA- | 10/6/80/4 | 4.28 | 55.8 | 2.2 |
| | H1100P | | | | |

The SFC process of the present invention can realize a decrease in production cost of a CNF-reinforced composite material.

### INDUSTRIAL APPLICABILITY

The process of the present invention can prepare a mixture (premix) by adding a fibrillation aid and a resin (high-density PE or the like) to a wood-derived pulp. The pulp can be fibrillated to the nano-level by melt-kneading the resultant mixture by using a double-screw extruder or the like. In this process, CNF can be efficiently produced from the wood-derived pulp by kneading treatment using the double-screw extruder of the like.

At the same time, the process can sufficiently disperse the resultant CNF in the resin. As a result, a composite resin material containing CNF and exhibiting high mechanical properties can be produced. A composite resin material exhibiting higher mechanical properties can be produced by using, as a raw material, the wood-derived pulp treated with a dispersant (preferably, a polymer dispersant).

The process of the present invention permits the preparation of CNF and dispersion of CNF in the resin to be performed by a single operation. This is a simultaneous process (Simultaneous nano-Fibrillation Compounding Process, SFC process) of nano-fibrillation (fibrillation to the nano-level) and nano-dispersion (dispersion in the nano-level). The SFC process can realize a decrease in production of the CNF-reinforced composite material. This process is a process capable of producing a composite material without using a special dehydrator and producing a composite resin material with a low cost and little environmental load.

1. A resin composition comprising cellulose fibers, a fibrillation aid, and a resin.

2. The resin composition according to claim 1, further comprising a dispersant.

3. The resin composition according to claim 1, wherein the cellulose fibers are cellulose nanofibers.

4. The resin composition according to claim 1, wherein the fibrillation aid is at least one component selected from the group consisting of urea, biuret, biurea, hydrazide, urea derivatives, saccharides, saccharide alcohols, organic acids, organic acid salts, and decomposed products thereof.

5. The resin composition according to claim 2, wherein the dispersant is a component having a resin-affinitive segment A and a cellulose-affinitive segment B and having a block copolymer structure or a gradient copolymer structure.

6. A method for producing a resin composition containing cellulose fibers, a fibrillation aid, and a resin, the method comprising, in order:
(1) a step of mixing pulp with a resin; and
(2) a step of fibrillating the pulp by kneading the mixture of the step (1) to produce a resin composition containing cellulose fibers and a resin,
wherein at least one step selected from the mixing step in the step (1), the kneading step in the step (2), and the fibrillation step in the step (2) includes a step of adding the fibrillation aid.

7. The method according to claim 6, wherein at least one step selected from the mixing step in the step (1), the kneading step in the step (2), and the fibrillation step in the step (2) includes a step of adding the dispersant.

8. The method according to claim 6, wherein the cellulose fibers contained in the resin composition are cellulose nanofibers.

9. (canceled)

10. (canceled)

11. The resin composition according to claim 1, wherein the mixing ratio of the fibrillation aid is 0.01% to 20% by mass.

12. The resin composition according to claim 2, wherein the mixing ratio of the dispersant is 0.1% to 20% by mass.

13. A molded product formed by using the resin composition according to claim 1.

14. The method according to claim 6, wherein the freeness of the pulp is 15 to 720 cc.

15. The method according to claim 6, wherein the fibrillation aid is at least one component selected from the group consisting of urea, biuret, biurea, hydrazide, urea derivatives, saccharides, saccharide alcohols, organic acids, organic acid salts, and decomposed products thereof.

16. A method for producing a molded product, comprising molding the resin composition produced by the method according to claim 6.
